(19) United States
(12) Patent Application Publication
(10) Pub. No.: US 2016/0355705 A1
(43) Pub. Date: Dec. 8, 2016

(54) LAMINATE FOR TOUCH PANEL AND ADHESIVE SHEET

(71) Applicant: FUJIFILM Corporation, Tokyo (JP)

(72) Inventors: Takatsugu KAWANO, Ashigarakami-gun (JP); Yohei ISHIJI, Ashigarakami-gun (JP); Yuya YAMAMOTO, Ashigarakami-gun (JP)

(73) Assignee: FUJIFILM Corporation, Tokyo (JP)

(21) Appl. No.: 15/241,215

(22) Filed: Aug. 19, 2016

Related U.S. Application Data
(63) Continuation of application No. PCT/JP2015/050651, filed on Jan. 13, 2015.

(30) Foreign Application Priority Data
Feb. 28, 2014 (JP) 2014-039054
Dec. 26, 2014 (JP) 2014-265224

(51) Int. Cl. C09J 7/02; B32B 15/082; B32B 15/02; B32B 7/12; B32B 3/10

(52) U.S. Cl. CPC C09J 7/0264; B32B 7/12; B32B 3/10; B32B 15/02; B32B 15/082; B32B 2457/208; B32B 2307/202; C09J 2415/00; C09J 2433/00; G06F 3/044

(57) ABSTRACT

A laminate for a touch panel includes a resin substrate which has a thermal expansion factor of 2 ppm/° C. to 200 ppm/° C.; a conductive portion which is arranged on the resin substrate, and has a mesh pattern formed of a plurality of metal thin wires; and an adhesive layer which is arranged to cover a surface of the resin substrate on the conductive portion side and the conductive portion, in which thermal stress obtained by a predetermined expression is less than or equal to 1,800 Pa, and peeling strength of the adhesive layer with respect to the resin substrate under an environment of a temperature of 85° C. and humidity of 85% is greater than or equal to 0.40 N/25 mm.

### CROSS-REFERENCE TO RELATED APPLICATIONS

This application is a Continuation of PCT International Application No. PCT/JP2015/050651 filed on Jan. 13, 2015, which claims priority under 35 U.S.C §119 (a) to Japanese Patent Application No. 2014-039054 filed on Feb. 28, 2014 and Japanese Patent Application No. 2014-265224 filed on Dec. 26, 2014. Each of the above application(s) is hereby expressly incorporated by reference, in its entirety, into the present application.

### BACKGROUND OF THE INVENTION

1. Field of the Invention

The present invention relates to a laminate for a touch panel, and in particular, relates to a laminate for a touch panel satisfying a predetermined relationship between thermal stress and peeling strength.

In addition, the present invention relates to an adhesive sheet which is used in the laminate for a touch panel described above.

2. Description of the Related Art

Recently, a touch panel has been increasingly mounted on a mobile phone, a portable game device, or the like, and for example, an electrostatic capacitance type touch panel (hereinafter, also simply referred to as a touch panel) in which multipoint detection is able to be performed has been attracting attention.

In general, an adhesive sheet which is transmissively visible has been used for adhesion between each member such as a display device or a touch panel sensor at the time of manufacturing a touch panel, and various adhesive sheets have been proposed.

For example, in WO2010/027041A, a photocurable type adhesive composition for adhesion of a touch panel which contains (A) a (meth)acrylate oligomer containing polyisoprene, polybutadiene, or polyurethane in a skeleton, and (B) a softening component is disclosed.

### SUMMARY OF THE INVENTION

Recently, even in a case where a touch panel is left to stand under a high temperature and high humidity environment, it has been required that a malfunction does not occur as one of performance requirements which are required for a touch panel. Furthermore, a resin substrate, a conductive portion which is arranged on the resin substrate, functions as a sensor unit, and is formed of a metal thin wire, and an adhesive layer may be arranged in this order as a partial configuration of the touch panel.

The present inventors have studied the properties of the adhesive layer formed of the photocurable type adhesive composition for adhesion of a touch panel disclosed in WO2010/027041A under a high temperature and high humidity environment by arranging the adhesive layer on a conductive portion including a metal thin wire, and have found that the disconnection of the metal thin wire in the conductive portion occurs under a high temperature and high humidity environment. The occurrence of such disconnection of the metal thin wire may cause the malfunction of the touch panel.

In consideration of the circumstances described above, an object of the present invention is to provide a laminate for a touch panel in which the disconnection of a metal thin wire does not occur under a high temperature and high humidity environment.

In addition, another object of the present invention is to provide an adhesive sheet which is used in the laminate for a touch panel described above.

As a result of intensive studies for attaining the objects described above, the present inventors have found that a desired effect is able to be obtained by controlling thermal stress between the adhesive layer and the resin substrate, and peeling strength.

That is, it has been found that the objects described above are able to be attained by the following configurations.

(1) A laminate for a touch panel, comprising: a resin substrate which has a thermal expansion factor of 2 ppm/° C. to 200 ppm/° C.; a conductive portion which is arranged on the resin substrate, and has a mesh pattern formed of a metal thin wire; and an adhesive layer which is arranged to cover a surface of the resin substrate on the conductive portion side and the conductive portion, in which thermal stress obtained by Expression (1) described below is less than or equal to 1,800 Pa, and peeling strength of the adhesive layer with respect to the resin substrate under an environment of a temperature of 85° C. and humidity of 85% is greater than or equal to 0.40 N/25 mm.

(2) The laminate for a touch panel according to (1), in which the adhesive layer is an adhesive layer obtained by photocuring a photocurable adhesive composition containing components (A) to (F) described below:

(A) a rubber,

(B) a crosslinking agent,

(C) a monofunctional (meth)acrylic monomer having at least one group selected from the group consisting of a straight chain or branch alkyl group having greater than or equal to 8 carbon atoms and an alicyclic hydrocarbon group,

(D) a photopolymerization initiator,

(E) an adhesiveness providing agent, and

(F) a compound which has at least one reactive group selected from the group consisting of an epoxy group, an oxetanyl group, an isocyanate group, a carbodiimide group, and an amino group, and at least one polymerizable group selected from the group consisting of a radically polymerizable group and an epoxy group, and is different from the components (A) to (E).

(3) The laminate for a touch panel according to (2), in which a content of the component (C) in the photocurable adhesive composition is 10 mass % to 45 mass % with respect to the total mass of the components (A) to (F), and a content of the component (E) in the photocurable adhesive composition is 25 mass % to 50 mass % with respect to the total mass of the components (A) to (F).

(4) The laminate for a touch panel according to (2) or (3), in which the component (B) contains one selected from the group consisting of polybutadiene, polyisoprene, hydrogenated polybutadiene, and hydrogenated polyisoprene, which have a (meth)acryloyl group.

(5) The laminate for a touch panel according to any one of (2) to (4), in which the component (F) is a compound denoted by General Formula (X).

(6) The laminate for a touch panel according to any one of (2) to (5), in which a content of the component (F) in the photocurable adhesive composition is 2 mass % to 20 mass % with respect to the total mass of the component (C).

(7) An adhesive sheet obtained by photocuring a photocurable adhesive composition containing components (A) to (F) described below:

(A) a rubber,

(B) a crosslinking agent,

(C) a monofunctional (meth)acrylic monomer having at least one group selected from the group consisting of a straight chain or branch alkyl group having greater than or equal to 8 carbon atoms and an alicyclic hydrocarbon group,

(D) a photopolymerization initiator,

(E) an adhesiveness providing agent, and

(F) a compound which has at least one reactive group selected from the group consisting of an epoxy group, an oxetanyl group, an isocyanate group, a carbodiimide group, and an amino group, and at least one polymerizable group selected from the group consisting of a radically polymerizable group and an epoxy group, and is different from the components (A) to (E).

(8) The adhesive sheet according to (7), in which a content of the component (C) in the photocurable adhesive composition is 10 mass % to 45 mass % with respect to the total mass of the components (A) to (F), and a content of the component (E) in the photocurable adhesive composition is 25 mass % to 50 mass % with respect to the total mass of the components (A) to (F).

(9) The adhesive sheet according to (7) or (8), in which the component (B) contains one selected from the group consisting of polybutadiene, polyisoprene, hydrogenated polybutadiene, and hydrogenated polyisoprene, which have a (meth)acryloyl group.

(10) The adhesive sheet according to any one of (7) to (9), in which the component (F) is a compound denoted by General Formula (X).

(11) The adhesive sheet according to any one of (7) to (10), in which a content of the component (F) in the photocurable adhesive composition is 2 mass % to 20 mass % with respect to the total mass of the component (C).

According to the present invention, it is possible to provide a laminate for a touch panel in which the disconnection of a metal thin wire does not occur under a high temperature and high humidity environment.

In addition, according to the present invention, it is also possible to provide an adhesive sheet which is used in the laminate for a touch panel described above.

### BRIEF DESCRIPTION OF THE DRAWINGS

FIG. 1 is a partial sectional view of a first embodiment of a laminate for a touch panel of the present invention.

FIG. 2 is a partial plan view of the first embodiment of the laminate for a touch panel of the present invention.

FIG. 3 is a sectional view of an electrostatic capacitance type touch panel of the present invention.

FIG. 4 is a plan view of one embodiment of the electrostatic capacitance type touch panel sensor.

FIG. 5 is a sectional view cut along cutting line A-A illustrated in FIG. 4.

FIG. 6 is an enlarged plan view of a first detection electrode.

FIG. 7 is a partial sectional surface of another embodiment of the electrostatic capacitance type touch panel sensor.

FIG. 8 is a partial sectional surface of another embodiment of the electrostatic capacitance type touch panel sensor.

FIG. 9 is a schematic view of a sample for evaluation which is used in a temperature dependency evaluation test.

FIG. 10 is an example of a result of the temperature dependency evaluation test.

### DESCRIPTION OF THE PREFERRED EMBODIMENTS

Hereinafter, a laminate for a touch panel and an adhesive sheet of the present invention will be described.

Furthermore, herein, a numerical range denoted by using “to” indicates a range including numerical values before and after “to” as the lower limit value and the upper limit value.

Furthermore, as described above, examples of a characteristic point of a laminate for a touch panel of the present invention include controlling thermal stress between an adhesive layer and a resin substrate, and the peeling strength of the adhesive layer with respect to the resin substrate. The present inventors have conducted intensive studies about factors in the occurrence of the disconnection of a metal thin wire according to the related art, and have found that the factors include the occurrence of a shift on a boundary surface between the adhesive layer and the resin substrate under a high temperature and high humidity environment, and a decrease in the adhesiveness of the adhesive layer with respect to the resin substrate. More specifically, according to the occurrence of the shift on the boundary surface between the adhesive layer and the resin substrate, stress (a shear force) generated due to a difference in the thermal stress of both of the adhesive layer and the resin substrate under a high temperature and high humidity environment is imparted to the metal thin wire in a conductive portion, and thus, the disconnection of the metal thin wire occurs. In addition, according to the decrease in the adhesiveness of the adhesive layer with respect to the resin substrate, the stress with respect to the metal thin wire described above increases, and thus, the disconnection of the metal thin wire more easily occurs. The present inventors have found that the disconnection of the metal thin wire described above rarely occurs by controlling the thermal stress between the adhesive layer and the resin substrate to be less than or equal to a predetermined value, and by increasing adhesiveness between the adhesive layer and the resin substrate at a predetermined temperature, on the basis of the findings described above. Furthermore, means for attaining the characteristics described above are not particularly limited, and as described below, a desired effect is able to be easily obtained by using a component (F).

Hereinafter, a preferred embodiment of the laminate for a touch panel of the present invention will be described with reference to the drawings.

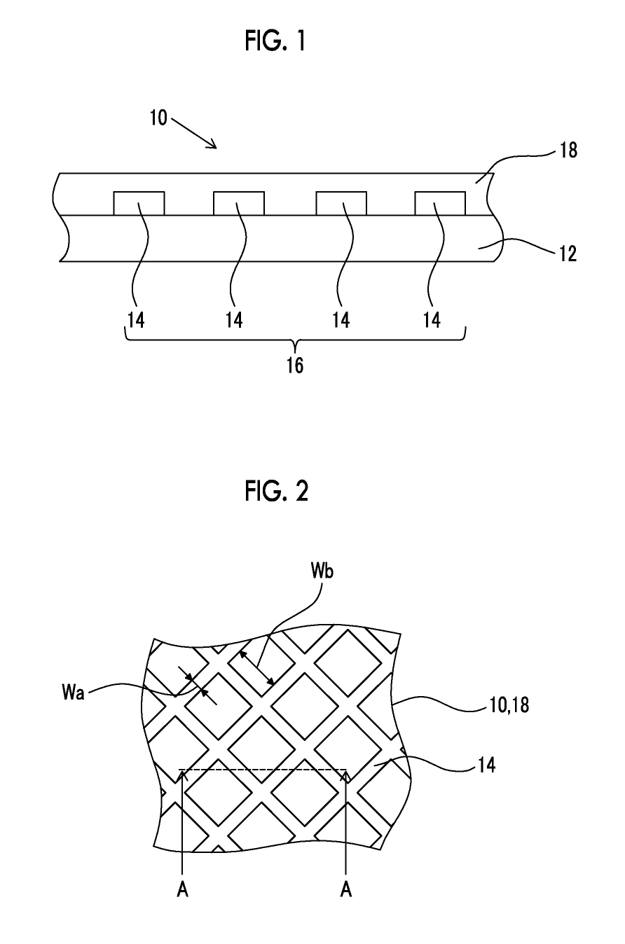

In FIG. 1, a partial sectional view of a first embodiment of a laminate for a touch panel 10 of the present invention is illustrated. In addition, FIG. 2 illustrates a partial plan view of the first embodiment of the laminate for a touch panel 10. Furthermore, FIG. 1 is a sectional view cut along cutting line A-A illustrated in FIG. 2. The laminate for a touch panel 10 comprises a resin substrate 12, a conductive portion 16 which is arranged on the resin substrate 12 and is formed of a plurality of metal thin wires 14, and an adhesive layer 18 which is arranged to be in contact with the surface of the resin substrate 12 and the conductive portion 16 (arranged to cover the surface of the resin substrate 12 and the conductive portion 16). Furthermore, as illustrated in FIG. 2, the conductive portion 16 includes a mesh pattern configured of the metal thin wire 14.

The laminate for a touch panel 10 satisfies at least two requirements described below.

Requirement (A): a thermal stress obtained by Expression (1) described below is less than or equal to 1,800 Pa

Requirement (B): the peeling strength of the adhesive layer with respect to the resin substrate under an environment of a temperature of 85° C. and humidity of 85% is greater than or equal to 0.4 N/25 mm

Hereinafter, first, the requirements (A) and (B) will be described in detail, and then, each member will be described in detail.

The thermal stress denoted by Expression (1) indicates stress which is generated between the resin substrate 12 and the conductive portion 16 at the time of leaving the laminate for a touch panel 10 to stand under an environment of 85° C.

In the laminate for a touch panel 10, the thermal stress obtained by Expression (1) is less than or equal to 1,800 Pa, is more preferably less than or equal to 1,500 Pa, and is even more preferably less than or equal to 800 Pa, from the viewpoint of less occurrence of the disconnection of the metal thin wire (hereinafter, also simply referred to as “from the viewpoint of a more excellent effect of the present invention”). The lower limit is not particularly limited, and is most preferably 0, but in general, the lower limit may be greater than or equal to 200 Pa.

In a case where the thermal stress is greater than 1,800 Pa, the disconnection of the metal thin wire easily occurs.

σ_{A}={|α_{B}−α_{A}|×ΔT×h_{B}×E_{A}×E_{B}}/(E_{A}×h_{A}+E_{B}×h_{B}) Expression (1)

(σ_{A}: thermal stress, α_{A}: a thermal expansion factor (ppm/° C.) of an adhesive layer, α_{B}: a thermal expansion factor (ppm/° C.) of a resin substrate, ΔT: 85° C.—room temperature, E_{A}: a modulus of elasticity (Pa) of the adhesive layer at 85° C., E_{B}: a modulus of elasticity (Pa) of the resin substrate at 85° C., h_{A}: a thickness (mm) of the adhesive layer, and h_{B}: a thickness (mm) of the resin substrate)

Furthermore, in the expression described above, |α_{B}−α_{A}| indicates the absolute value of a difference between α_{B} and α_{A}.

In Expression (1), α_{A} and α_{B} each indicate the thermal expansion factor (ppm/° C.) of the adhesive layer and the resin substrate.

The size of the thermal expansion factor of the adhesive layer is not particularly limited insofar as the thermal stress described above is in a predetermined range, but the size of the thermal expansion factor is preferably 20 ppm/° C. to 1,000 ppm/° C., and is more preferably 300 ppm/° C. to 600 ppm/° C., from the viewpoint of a more excellent effect of the present invention.

In addition, as described below, the size of the thermal expansion factor of the resin substrate is 2 ppm/° C. to 200 ppm/° C.

In addition, the size of the value of |α_{B}−α_{A}| is not particularly limited insofar as the thermal stress described above is in a predetermined range, but the size of the value of |α_{B}-α_{A}| is preferably 0 ppm/° C. to 1,000 ppm/° C., and is more preferably 0 ppm/° C. to 600 ppm/° C., from the viewpoint of a more excellent effect of the present invention.

As a measurement method of the thermal expansion factor of the adhesive layer and the resin substrate described above, measurement is performed on the basis of JIS K7197. Specifically, a test sample having a length of 30 mm, a width of 5 mm, and a thickness of 800 μm is set in a compressing mode, and a thermal expansion change at a temperature of 25° C. to 85° C. in a thickness direction is measured in conditions of a temperature rising rate of 2° C./min by using a thermomechanical measurement device TMA-60 manufactured by Shimadzu Corporation. Furthermore, when the sample is prepared, the sample may be manufactured by superposing a plurality of sheets having a thickness of less than 800 μm (for example, by superposing eight sheets having a of 100 μm).

ΔT indicates a temperature difference between 85° C. which is a temperature for measuring the thermal stress and room temperature. Furthermore, here, the room temperature indicates room temperature under an environment of performing a test, and in general, it is preferable that the room temperature indicates 23° C.

E_{A} and E_{B} each represent the modulus of elasticity (Pa) of the adhesive layer and the resin substrate at 85° C.

The size of the modulus of elasticity (Pa) of the adhesive layer at 85° C. is not particularly limited insofar as the thermal stress described above is in a predetermined range, but is preferably 1×10³ Pa to 5×10⁵ Pa, and is more preferably 1×10⁻⁴ Pa to 1×10⁵ Pa, from the viewpoint of a more excellent effect of the present invention.

The size of the modulus of elasticity (Pa) of the resin substrate at 85° C. is not particularly limited insofar as the thermal stress described above is in a predetermined range, but is preferably greater than or equal to 1×10⁷ Pa from the viewpoint of a more excellent effect of the present invention.

A dynamic viscoelasticity measurement method described below is used as a measurement method of the modulus of elasticity (Pa) of the adhesive layer and the resin substrate. Specifically, an adhesive layer (an adhesive sheet) and a resin substrate which have a width of 5 mm, a length of 25 mm, and a thickness of 200 μm are used as a sample. The sample is set in a device (DVA-225 manufactured by IPROS CORPORATION) having a distance between chucks of 20 mm, and is left to stand in an environment of a temperature of 85° C. and humidity of 85% for 1 hour, and in this environment (a temperature of 85° C. and humidity of 85%), evaluation is performed at a measurement frequency of 1 Hz in a pulling mode based on JIS K7244. Furthermore, when the adhesive layer (the adhesive sheet) having the thickness described above is prepared, a sample of 200 μm may be directly manufactured, or a sample may be manufactured by superposing a plurality of sheets having a thickness less than 200 μm (for example, by superposing two sheets of 100 μm).

h_{A} and h_{B} each represent the thickness (mm) of the adhesive layer and the resin substrate.

The thickness (mm) of the adhesive layer is not particularly limited insofar as the thermal stress described above is in a predetermined range, but is preferably 0.02 mm to 0.5 mm, and is more preferably 0.05 mm to 0.3 mm, from the viewpoint of a more excellent effect of the present invention.

The thickness (mm) of the resin substrate is not particularly limited insofar as the thermal stress described above is in a predetermined range, but is preferably 0.05 mm to 2 mm, and is more preferably 0.1 mm to 1 mm, from the viewpoint of a more excellent effect of the present invention.

Furthermore, the thickness described above represent an average value, and is obtained by measuring the thicknesses of arbitrary ten points of the adhesive layer (or the resin substrate), and by arithmetically averaging the measured thicknesses.

The peeling strength of the adhesive layer with respect to the resin substrate under an environment of a temperature of 85° C. and humidity of 85% is greater than or equal to 0.40 N/25 mm, and is preferably greater than or equal to 0.50 N/25 mm, is more preferably greater than or equal to 0.55 N/25 mm, is even more preferably greater than or equal to 0.60 N/25 mm, and is particularly preferably greater than or equal to 0.80 N/25 mm, from the viewpoint of a more excellent effect of the present invention. The upper limit is not particularly limited, but in general, the upper limit may be less than or equal to 1.80 N/25 mm.

In a case where the peeling strength is less than 0.40 N/25 mm, the disconnection of the metal thin wire easily occurs.

As a measurement method of the peeling strength, first, one surface of an adhesive layer (a width of 25 mm, a length of 40 mm, and a thickness of 100 μm) is bonded to a resin substrate (a width of 30 mm and a length of 50 mm) which is used in a laminate for a touch panel in a width direction, a polyimide sheet (KAPTON 100H, a width of 30 mm, a length of 120 mm, and a thickness of 25 μm) is bonded to the other surface of the adhesive layer in the width direction, the bonded body is subjected to a pressure defoaming treatment at a temperature of 40° C. and a pressure of 5 atm for 60 minutes and is left to stand at room temperature (approximately 23° C.) for 1 day, and thus, a sample for adhesion force evaluation is prepared, and then, the sample is set in a TENSILON device provided with a thermostatic tank such that one end of the polyimide sheet which is not in contact with the adhesive layer is pulled (peeled) in a direction of 180 degrees, the thermostatic tank is left to stand in an environment of a temperature of 85° C. and humidity of 85% for 30 minutes, and in this environment (a temperature of 85° C. and humidity of 85%), a 180-degree peeling test is performed at a speed of 300 mm/sec.

Hereinafter, each member configuring the laminate for a touch panel will be described in detail.

<Resin Substrate>

The resin substrate 12 is a substrate which supports the conductive portion 16 and the adhesive layer 18 described below.

The thermal expansion factor of the resin substrate 12 is 2 ppm/° C. to 200 ppm/° C., and is preferably 15 ppm/° C. to 180 ppm/° C., and is more preferably 20 ppm/° C. to 160 ppm/° C., from the viewpoint of a more excellent effect of the present invention.

The material of the resin substrate 12 is not particularly limited insofar as the material of the substrate exhibits the thermal expansion factor described above, and examples of the material of the resin substrate 12 include a polyether sulfone-based resin, a polyacrylic resin, a polyurethane-based resin, a polyester-based resin (for example, polyethylene terephthalate and polyethylene naphthalate), a polycarbonate-based resin, a polysulfone-based resin, a polyamide-based resin, a polyarylate-based resin, a polyolefin-based resin, a cellulose-based resin, a polyvinyl chloride-based resin, a cycloolefin-based resin, and the like. Among them, the polyethylene terephthalate, the polyethylene naphthalate, or the polyolefin-based resin is preferable.

The range of the thickness of the resin substrate 12 is as described above.

In addition, it is preferable that the resin substrate 12 suitably transmits light. Specifically, it is preferable that the total light transmittance of the resin substrate 12 is 85% to 100%.

Furthermore, it is preferable that a functional group (hereinafter, also referred to as a functional group X) which is able to react with a reactive group included in a component (F) described below is contained in the surface of the resin substrate 12. By containing the functional group X, a crosslinking reaction between the component (F) and the resin substrate 12 easily progresses at the time of exposing the laminate for a touch panel under a high temperature and high humidity environment, and thus, the adhesiveness between the resin substrate 12 and the adhesive layer 18 is improved under a high temperature and high humidity environment.

The type of functional group X is not particularly limited, and an optimum group is suitably selected according to the type of reactive group described below. Examples of the functional group X include the following combinations.

(1) a reactive group of “an epoxy group or an oxetanyl group” and a functional group X of “a hydroxyl group, a carboxyl group, or an amino group”

(2) a reactive group of “an isocyanate group” and a functional group X of “a hydroxyl group, a carboxyl group, or an amino group”

(3) a reactive group of “a carbodiimide group” and a functional group X of “a carboxyl group”

(4) a reactive group of “an amino group” and a functional group X of “an isocyanate group, an epoxy group, and an oxetanyl group”

That is, a hydroxyl group, a carboxyl group, an amino group, an isocyanate group, an epoxy group, an oxetanyl group, or the like is able to be preferably used as the reaction group X.

Furthermore, the resin substrate 12 may be a laminate (multilayer body) formed of a plurality of layers. In this case, the thermal expansion factor described above may be exhibited as the entire laminate.

A layer containing a compound having a group which is able to react with the reactive group of the component (F) described below (hereinafter, also suitably referred to as an “undercoat layer”) may be arranged between the resin substrate 12 and the conductive portion 16. That is, a resin laminate including the resin substrate 12 and the undercoat layer may be formed. Furthermore, it is preferable that the range of the thermal expansion factor of the resin laminate is the range of the thermal expansion factor of the resin substrate 12 described above.

The structure of the compound described above which is contained in the undercoat layer is not particularly limited insofar as the compound has a group (the functional group X) which is able to react with the reactive group of the component (F). Furthermore, the definition of the functional group X is as described above.

The compound may be a low molecular compound or a high molecular compound, and it is preferable that the compound is a high molecular compound having a repeating unit which has the functional group X described above. Examples of the high molecular compound include an acrylic polymer. Furthermore, the acrylic polymer may have a repeating unit other than a repeating unit derived from an acrylic monomer (for example, a repeating unit derived from a styrene monomer).

The thickness of the undercoat layer is not particularly limited, but is preferably 0.02 μm to 0.3 μm, and is more preferably 0.03 μm to 0.2 μm, from the viewpoint of a more excellent effect of the present invention.

Among them, examples of a preferred embodiment of the high molecular compound include a polymer (a copolymer) denoted by General Formula (X) described below from the viewpoint of preventing moisture infiltration.

-(A)x-(B)y-(C)z-(D)w- General Formula (X):

Furthermore, in General Formula (X), A, B, C, and D each represent a repeating unit described below.

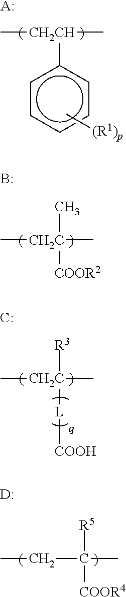

R¹ represents a methyl group or a halogen atom, and preferably represents a methyl group, a chlorine atom, or a bromine atom. p represents an integer of 0 to 2, is preferably 0 or 1, and is more preferably 0.

R² represents a methyl group or an ethyl group, and is preferably a methyl group.

R³ represents a hydrogen atom or a methyl group, and preferably represents a hydrogen atom. L represents a divalent linking group, and is preferably a group denoted by General Formula (Y) described below.

-(CO—X¹)r-X²— General Formula (Y):

In the formula, X¹ represents an oxygen atom or —NR³⁰—. Here, R³⁰ represents a hydrogen atom, an alkyl group, aryl group, or an acyl group, which may each have a substituent group (for example, a halogen atom, a nitro group, a hydroxyl group, and the like). R³⁰ preferably represents a hydrogen atom, an alkyl group having 1 to 10 carbon atoms (for example, a methyl group, an ethyl group, an n-butyl group, an n-octyl group, and the like), and an acyl group (for example, an acetyl group, a benzoyl group, and the like). An oxygen atom or —NH— is particularly preferable as X¹.

X² represents an alkylene group, an arylene group, an alkylene arylene group, an arylene alkylene group, or an alkylene arylene alkylene group, and —O—, —S—, —OCO—, —CO—, —COO—, —NH—, —SO₂—, —N(R³¹)—, —N(R³¹)SO₂—, and the like may be inserted in the middle of the groups. Here, R³¹ represents a straight chain or branch alkyl group having 1 to 6 carbon atoms such as a methyl group, an ethyl group, and an isopropyl group. Preferred examples of X² are able to include a dimethylene group, a trimethylene group, a tetramethylene group, an o-phenylene group, an m-phenylene group, a p-phenylene group, —CH₂CH₂OCOCH₂CH₂—, —CH₂CH₂OCO(C₆H₄)—, and the like.

r represents 0 or 1.

q represents 0 or 1, and is preferably 0.

R⁴ represents an alkyl group having 5 to 80 carbon atoms, an alkenyl group, or an alkynyl group, is preferably an alkyl group having 5 to 50 carbon atoms, is more preferably an alkyl group having 5 to 30 carbon atoms, and is even more preferably an alkyl group having 5 to 20 carbon atoms.

R⁵ represents a hydrogen atom, a methyl group, an ethyl group, a halogen atom, or —CH₂COOR⁶, is preferably a hydrogen atom, a methyl group, a halogen atom, and —CH₂COOR⁶, and is more preferably a hydrogen atom, a methyl group, and —CH₂COOR⁶, and is particularly preferably a hydrogen atom.

R⁶ represents a hydrogen atom or an alkyl group having 1 to 80, and may be identical to or different from R⁴, and the number of carbon atoms of R⁶ is preferably 1 to 70, and is more preferably 1 to 60.

In General Formula (X), x, y, z, and w each represent a molar ratio of each repeating unit.

x is 3 mol % to 60 mol %, is preferably 3 mol % to 50 mol %, and is more preferably 3 mol % to 40 mol %. y is 30 mol % to 96 mol %, is preferably 35 mol % to 95 mol %, and is more preferably 40 mol % to 90 mol %. z is 0.5 mol % to 25 mol %, is preferably 0.5 mol % to 20 mol %, and is more preferably 1 mol % to 20 mol %. w is 0.5 mol % to 40 mol %, and is preferably 0.5 mol % to 30 mol %.

In General Formula (X), a case where x is 3 mol % to 40 mol %, y is 40 mol % to 90 mol %, z is 0.5 mol % to 20 mol %, and w is 0.5 mol % to 10 mol % is particularly preferable.

The polymer denoted by General Formula (X) may have a repeating unit other than the repeating units denoted by General Formulas (A), (B), (C), and (D). It is preferable that the polymer denoted by General Formula (X) has a repeating unit denoted by General Formula (E) described below other than the repeating units denoted by General Formulas (A), (B), (C), and (D) described above.

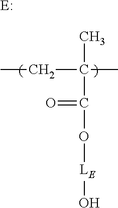

In the formula described above, L_{E} represents an alkylene group, is preferably an alkylene group having 1 to 10 carbon atoms, is more preferably an alkylene group having 2 to 6 carbon atoms, and is even more preferably an alkylene group having 2 to 4 carbon atoms.

<Conductive Portion>

The conductive portion 16 is arranged on the resin substrate 12 described above, and has a mesh pattern formed of a plurality of metal thin wires 14. As described below, it is preferable that the conductive portion 16 mainly configures a sensor unit of a touch panel sensor.

As illustrated in FIG. 2, the conductive portion 16 has the mesh pattern formed of the plurality of metal thin wires 14. That is, the conductive portion 16 includes a plurality of opening portions (lattices) 36 formed by intersecting metal thin wires 14.

A line width Wa of the metal thin wire 14 is not particularly limited, but is preferably 1 μm to 50 μm, and is more preferably 2 μm to 20 μm, from the viewpoint of a more excellent effect of the present invention.

The thickness of the metal thin wire 14 is not particularly limited, but is able to be selected from 0.00001 mm to 0.2 mm, and is preferably less than or equal to 30 μm, is more preferably less than or equal to 20 μm, is even more preferably 0.01 μm to 9 μm, and is most preferably 0.05 μm to 5 μm, from the viewpoint of conductivity and visibility.

The opening portion 36 is an opening region surrounded by the metal thin wire 14. A length Wb of one side of the opening portion 36 is preferably less than or equal to 800 μm, is more preferably less than or equal to 600 μm, and is even more preferably less than or equal to 400 μm, and is preferably greater than or equal to 5 μm, is more preferably greater than or equal to 30 μm, and is even more preferably greater than or equal to 80 μm. It is preferable that the arrangement pitch of the metal thin wire 14 is in the numerical range of Wb described above. Furthermore, herein, the arrangement pitch of the metal thin wire indicates the total length of Wa described above and Wb described above (the total length of the line width of the metal thin wire and the width of the opening portion).

The opening ratio is preferably greater than or equal to 85%, is more preferably greater than or equal to 90%, and is most preferably greater than or equal to 95%, from the viewpoint of visible light transmittance. The opening ratio corresponds to the ratio of a transmissive portion (the opening portion) to the entire conductive portion 16 excluding the metal thin wire 14.

In FIG. 2, the opening portion 36 is approximately in the shape of a diamond. Here, in addition to the shape, the opening portion 36 may have a polygonal shape (for example, a triangle, a rectangle, a hexagon, and a random polygon). In addition, one side may be in the shape of a straight line, a bend, or a circular arc. In a case where the one side is in the shape of a circular arc, for example, facing two sides may be in the shape of an outwardly projecting circular arc, and the other facing two sides may be in the shape of an inwardly projecting circular arc. In addition, each of the sides may be in the shape of a wave line in which an outwardly projecting circular arc and an inwardly projecting circular arc are continuous. Naturally, each of the sides may be in the shape of a sine curve.

Examples of the material of the metal thin wire 14 include a metal such as gold (Au), silver (Ag), copper (Cu), and aluminum (Al), an alloy, and the like. Among them, it is preferable that the material of the metal thin wire 14 is silver since the conductivity of the metal thin wire 14 is excellent.

It is preferable that a binder is contained in the metal thin wire 14 from the viewpoint of the adhesiveness between the metal thin wire 14 and the resin substrate 12.

Examples of the binder include at least one resin selected from the group consisting of an acrylic resin, a styrene-based resin, a vinyl-based resin, a polyolefin-based resin, a polyester-based resin, a polyurethane-based resin, a polyamide-based resin, a polycarbonate-based resin, a polydiene-based resin, an epoxy-based resin, a silicone-based resin, a cellulose-based polymer, and chitosan-based polymer, a copolymer formed of a monomer configuring the resin, and the like, since the adhesiveness between the metal thin wire 14 and the resin substrate 12 is more excellent.

In addition, a water-soluble polymer may be used as the binder. Specifically, examples of the water-soluble polymer include polysaccharides such as gelatin, carrageenan, polyvinyl alcohol (PVA), polyvinyl pyrrolidone (PVP), and starch, cellulose and a derivative thereof, polyethylene oxide, polysaccharide, polyvinyl amine, chitosan, polylysine, a polyacrylic acid, a polyalginic acid, a polyhyaluronic acid, carboxy cellulose, gum arabic, sodium alginate, and the like.

Furthermore, lime-treated gelatin and acid-treated gelatin may be used as the gelatin, a hydrolysate of the gelatin, a gelatin enzymic hydrolysate, and gelatin in which an amino group and a carboxyl group are modified (phthalated gelatin and acetylated gelatin) are able to be used.

A volume ratio of the metal and the binder (the volume of the metal/the volume of the binder) in the metal thin wire 14 is preferably greater than or equal to 1.0, and is more preferably greater than or equal to 1.5. By setting the volume ratio of the metal and the binder to be greater than or equal to 1.0, it is possible to further increase the conductivity of the metal thin wire 14. The upper limit is not particularly limited, but is preferably less than or equal to 6.0, is more preferably less than or equal to 4.0, and is even more preferably less than or equal to 2.5, from the viewpoint of productivity.

Furthermore, the volume ratio of the metal and the binder is able to be calculated by the density of the metal and the binder in the metal thin wire 14.

A manufacturing method of the metal thin wire 14 is not particularly limited, and a known method is able to be adopted. Examples of the manufacturing method include a method using silver halide described below. The method will be described below in detail.

<Adhesive Layer>

The adhesive layer 18 is a layer which is arranged on the surface of the resin substrate 12 described above (a region not including the conductive portion 16) and the conductive portion 16 to be in contact therewith, and exhibits adhesiveness. The adhesive layer 18 is arranged to cover the surface of the resin substrate 12 and the conductive portion 16.

The range of the thickness of the adhesive layer 18 is as described above.

For example, various adhesives such as a rubber-based adhesive, an acrylic adhesive, a silicone-based adhesive, and an urethane-based adhesive are able to be used as a specific example of an adhesive contained in the adhesive layer 18, and the acrylic adhesive is preferable.

Furthermore, here, the acrylic adhesive is an adhesive containing a polymer of a monomer component having an acrylate monomer and/or a methacrylate monomer (a (meth)acrylic polymer). The polymer described above is contained in the acrylic adhesive described above as a base polymer, and other components (an adhesiveness providing agent, rubber, and the like described below) may be contained.

One of preferred embodiments of the adhesive layer 18 includes an adhesive layer obtained by photocuring a photocurable adhesive composition (hereinafter, also simply referred to as a “composition”) containing components (A) to (F) described below from the viewpoint of a more excellent effect of the present invention. In particular, the component (F) has a polymerizable group, and thus, reacts with a material such as the component (C) which configures the adhesive layer at the time of manufacturing the adhesive layer. In addition, a reactive group in the molecule reacts with the surface of the resin substrate 12 under a high temperature and high humidity environment. That is, the component (F) becomes a component which is bonded to both of the resin substrate 12 and the adhesive layer 18, and thus, has a function of further increasing the adhesiveness between the resin substrate 12 and the adhesive layer 18.

(A) a rubber,

(B) a crosslinking agent,

(C) a monofunctional (meth)acrylic monomer having at least one group selected from the group consisting of a straight chain or branch alkyl group having greater than or equal to 8 carbon atoms and an alicyclic hydrocarbon group,

(D) a photopolymerization initiator,

(E) an adhesiveness providing agent, and

(F) a compound which has at least one reactive group selected from the group consisting of an epoxy group, an oxetanyl group, an isocyanate group, a carbodiimide group, and an amino group, and at least one polymerizable group selected from the group consisting of a radically polymerizable group and an epoxy group, and is different from the components (A) to (E).

Hereinafter, each of the components will be described in detail.

(Component (A): Rubber)

By containing the rubber in the composition, the adhesive layer is plasticized, and a preferred range of a modulus of elasticity is exhibited. That is, the rubber functions as a so-called plasticizer.

The type of rubber is not particularly limited, and examples of the rubber include natural rubber, polyisobutylene, polybutene, polyisoprene, polybutadiene, hydrogenated polyisoprene, hydrogenated polybutadiene, styrene butadiene rubber, or a copolymer of a combination arbitrary selected from the group consisting of the rubbers described above, and the like. Only one type of the rubber may be used, or two or more types thereof may be used in combination.

Furthermore, a polymerizable group (for example, a radically polymerizable group) is not included in the rubber.

The content of the rubber in the composition is not particularly limited, but is preferably 2 mass % to 30 mass %, and is more preferably 5 mass % to 15 mass %, with respect to the total mass of the components (A) to (F), from the viewpoint of a more excellent effect of the present invention.

Furthermore, in a case where two or more types of rubbers are used, it is preferable that the total content of the rubbers is in the range described above.

(Component (B): Crosslinking Agent)

The crosslinking agent indicates a compound having a plurality of (two or more) crosslinking groups (for example, radically polymerizable groups), and has a function of providing a crosslinking structure into an adhesive layer to be formed.

The type of crosslinking group is not particularly limited, examples of the crosslinking group preferably include a radically polymerizable group. Examples of the radically polymerizable group include a (meth)acryloyl group, an acryl amide group, a vinyl group, a styryl group, an allyl group, and the like. Among them, the methacryloyl group is preferable from the viewpoint of a more excellent effect of the present invention.

Furthermore, the (meth)acryloyl group is a concept including an acryloyl group and a methacryloyl group.

The type of the skeleton in the crosslinking agent is not particularly limited, but it is preferable that the crosslinking agent is one selected from the group consisting of polybutadiene, polyisoprene, hydrogenated polybutadiene, and hydrogenated polyisoprene is preferable from the viewpoint of a more excellent effect of the present invention. Among them, it is more preferable that the crosslinking agent is one selected from the group consisting of polybutadiene, polyisoprene, hydrogenated polybutadiene, and hydrogenated polyisoprene which have a (meth)acryloyl group.

The content of the crosslinking agent in the composition is not particularly limited, but is preferably 5 mass % to 35 mass %, and is more preferably 20 mass % to 30 mass %, with respect to the total mass of the components (A) to (F), from the viewpoint of a more excellent effect of the present invention.

In addition, the content of the crosslinking agent is preferably 10 mass % to 200 mass %, and is more preferably 25 mass % to 120 mass %, with respect to the total mass of a monofunctional (meth)acrylic monomer described below, from the viewpoint of a more excellent effect of the present invention.

Furthermore, in a case where two or more types of crosslinking agents are used, it is preferable that the total content of the crosslinking agents is in the range described above.

(Component (C): Monofunctional (Meth)Acrylic Monomer)

The monofunctional (meth)acrylic monomer is a monomer having at least one selected from the group consisting of a straight chain or branch alkyl group having greater than or equal to 8 carbon atoms and an alicyclic hydrocarbon group.

The monofunctional (meth)acrylic monomer is a polymerizable compound having one (meth)acryloyl group. Furthermore, the (meth)acryloyl group is a general term including both of a methacryloyl group and an acryloyl group.

The number of carbon atoms of the straight chain or branch alkyl group described above is greater than or equal to 8, and is preferably 8 to 30, and is more preferably 8 to 15, from the viewpoint of a more excellent effect of the present invention.

The alicyclic hydrocarbon group is not particularly limited, but an alicyclic hydrocarbon group having 3 to 30 carbon atoms is preferable, and an alicyclic hydrocarbon group having 5 to 20 carbon atoms is more preferable. The alicyclic hydrocarbon group may have a monocyclic hydrocarbon group or a polycyclic hydrocarbon group. Specific examples of the monocyclic hydrocarbon group include a cyclopentyl group, a cyclohexyl group, and the like. Specific examples of the polycyclic hydrocarbon group include an isobornyl group, an adamantyl group, and the like.

The content of the monofunctional (meth)acrylic monomer in the composition is not particularly limited, but is preferably 10 mass % to 45 mass %, and is more preferably 20 mass % to 30 mass %, with respect to the total mass of the components (A) to (F), from the viewpoint of a more excellent effect of the present invention.

Furthermore, in a case where two or more types of monofunctional (meth)acrylic monomers are used, it is preferable that the total content of the monofunctional (meth)acrylic monomers is in the range described above.

(Component (D): Photopolymerization Initiator)

The type of photopolymerization initiator is not particularly limited, and a known photopolymerization initiator (a radical photopolymerization initiator and a cationic photopolymerization initiator) is able to be used. Examples of the photopolymerization initiator include an alkyl phenone-based photopolymerization initiator, a methoxy ketone-based photopolymerization initiator, an acyl phosphine oxide-based photopolymerization initiator, a hydroxy ketone-based photopolymerization initiator (for example, IRGACURE184; 1,2-α-hydroxy alkyl phenone), an aminoketone-based photopolymerization initiator (for example, 2-methyl-1-[4-(methylthio) phenyl]-2-morpholino-propan-1-one (IRGACURE (Registered Trademark) 907)), and an oxime-based photopolymerization initiator.

Among them, one selected from the group consisting of monoacyl phosphine oxide (A1) and bisacyl phosphine oxide (A2) is preferable as the photopolymerization initiator.

The content of the photopolymerization initiator in the composition is not particularly limited, but is preferably 1.0 mass % to 5.0 mass %, and is more preferably 2.0 mass % to 4.0 mass %, with respect to the total mass of the components (A) to (F), from the viewpoint of a more excellent effect of the present invention.

Furthermore, in a case where two or more types of photopolymerization initiators are used, it is preferable that the total content of the photopolymerization initiators is in the range described above.

(Component (E): Adhesiveness Providing Agent)

A known adhesiveness providing agent in the field of a bonding agent or bonding preparation may be suitably selected and used as the adhesiveness providing agent. Examples of the adhesiveness providing agent include an adhesiveness providing resin, and examples of the adhesiveness providing resin include a rosin-based resin such as rosin ester, hydrogenated rosin ester, disproportionated rosin ester, and polymerization rosin ester; a coumarone indene-based resin such as a coumarone indene resin, a hydrogenated coumarone indene resin, a phenol modified coumarone indene resin, and an epoxy modified coumarone indene resin; an α-pinene resin and a β-pinene resin; a terpene-based resin such as a polyterpene resin, a hydrogenated terpene resin, an aromatic modified terpene resin, and a terpene phenolic resin; a petroleum-based resin such as an aliphatic petroleum resin, an aromatic petroleum resin, and an aromatic modified aliphatic petroleum resin, and the like. Only one type of the resin is able to be independently used, or two or more types thereof are able to be used in combination, and in particular, the rosin-based resin, the terpene-based resin, and the coumarone indene-based resin are preferable.

The content of the adhesiveness providing agent in the composition is not particularly limited, but is preferably 25 mass % to 50 mass %, and is more preferably 35 mass % to 45 mass %, with respect to the total mass of the components (A) to (F), from the viewpoint of a more excellent effect of the present invention.

In addition, the mass ratio of the mass of the adhesiveness providing agent to the total mass of the rubber and the crosslinking agent described above {(the mass of the adhesiveness providing agent/the total mass of the rubber and the crosslinking agent)×100} is not particularly limited, but is preferably 60 mass % to 300 mass %, and is more preferably 80 mass % to 200 mass %, from the viewpoint of a more excellent effect of the present invention.

Furthermore, in a case where two or more types of adhesiveness providing agents are used, it is preferable that that total content of the adhesiveness providing agents is in the range described above.

(Component (F): Compound Having Reactive Group and Polymerizable Group)

The component (F) is a compound which has at least one reactive group selected from the group consisting of an epoxy group, an oxetanyl group, an isocyanate group, a carbodiimide group, and an amino group, and at least one polymerizable group selected from the group consisting of a radically polymerizable group and an epoxy group, and is different from the components (A) to (E).

The reactive group is selected from the group consisting of the epoxy group, the oxetanyl group, the isocyanate group, the carbodiimide group, and the amino group, and the epoxy group is preferable from the viewpoint of a more excellent effect of the present invention.

The number of reactive groups is not particularly limited, but is preferably 1 to 3, and is more preferably 1, from the viewpoint of a more excellent effect of the present invention.

The polymerizable group is selected from the group consisting of the radically polymerizable group and the epoxy group, and the radically polymerizable group is preferable from the viewpoint of a more excellent effect of the present invention. Examples of the radically polymerizable group include a (meth)acryloyl group, an acryl amide group, a vinyl group, a styryl group, an allyl group, and the like. Among them, the (meth)acryloyl group is preferable from the viewpoint of a more excellent effect of the present invention.

The number of polymerizable groups is not particularly limited, but is preferably 1 or 2, and is more preferably 1, from the viewpoint of a more excellent effect of the present invention.

Furthermore, in a case where the reactive group is the epoxy group, and the polymerizable group is the epoxy group, the component (F) indicates a multifunctional epoxy compound having two or more epoxy groups.

In addition, the component (F) is a compound which is different from the components (A) to (E).

Examples of a preferred embodiment of the compound described above include a compound denoted by General Formula (X) described below.

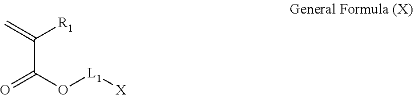

R₁ represents hydrogen, a methyl group, a trifluoromethyl group, or a hydroxy methyl group. Among them, the hydrogen or the methyl group is preferable from the viewpoint of a more excellent effect of the present invention.

L₁ represents alkylene or alkylene oxide. The number of carbon atoms in an alkylene portion of an alkylene group and an alkylene oxide group is not particularly limited, but is preferably 1 to 10, and is more preferably 1 to 5, from the viewpoint of a more excellent effect of the present invention.

X represents a group having at least one reactive group selected from an epoxy group, an oxetanyl group, an isocyanate group, a carbodiimide group, and an amino group. The group having the reactive group described above may include the reactive group described above, and examples of the group include a group denoted by -L₂-(R₂)ₙ. L₂ represents an organic group having a single bond or a divalent organic group. Examples of the divalent organic group include —O—, —CO—, —NH—, —CO—NH—, —COO—, —O—COO—, an alkylene group, an arylene group, a heterocyclic group (a heteroaryl group), and a divalent linking group selected from combinations thereof. R₂ represents a reactive group selected from an epoxy group, an oxetanyl group, an isocyanate group, a carbodiimide group, and an amino group. n represents an integer of greater than or equal to 1, and is preferably 1 to 3, and is more preferably 1. Furthermore, in a case where n is greater than or equal to 2, R₂ is bonded instead of a hydrogen atom in L₂.

The content of the described above component (F) in the composition is not particularly limited, but is preferably 0.5 mass % to 5 mass %, is more preferably 1 mass % to 5 mass %, and is even more preferably 1.5 mass % to 3 mass %, with respect to the total mass of the components (A) to (F), from the viewpoint of a more excellent effect of the present invention.

In addition, the content of the mass of the component (F) is preferably 2 mass % to 40 mass %, is more preferably 2 mass % to 20 mass %, and is even more preferably 4 mass % to 15 mass %, with respect to the total mass of the component (C) described above, from the viewpoint of a more excellent effect of the present invention.

Furthermore, in a case where two or more types of components (F) are used, it is preferable that the total content of the components (F) is in the range described above.

The composition described above contains the components (A) to (F), and may contain components other than the components (A) to (F).

For example, the composition, as necessary, may contain a solvent. Examples of the solvent to be used are able to include water, an organic solvent (for example, alcohols such as methanol, ketones such as acetone, amides such as formamide, sulfoxides such as dimethyl sulfoxide, esters such as ethyl acetate, ethers, and the like), or a mixed solvent thereof.

In addition, the composition may contain a chain transfer agent. The type of chain transfer agent is not particularly limited, and a known chain transfer agent (for example, 1-dodecane thiol, trimethylol propane tristhiopropionate, pentaerythritol tetrakisthiopropionate, and the like) is used. The content of the chain transfer agent is not particularly limited, and is preferably 1 mass % to 4 mass % with respect to the total mass of the components (A) to (F).

Various known additives of the related art such as a surface lubricant, a leveling agent, an antioxidant, a corrosion inhibitor, a light stabilizer, an ultraviolet absorbent, a polymerization inhibitor, a silane coupling agent, an inorganic or organic filler, a metal powder, and a powder of a pigment or the like, particles, and a foil-like material are able to be suitably added to the composition in addition to the components described above according to the application.

In the adhesive layer, it is preferable that the temperature dependency of a specific dielectric constant which is obtained from a temperature dependency evaluation test described below is less than or equal to 30% from the viewpoint of less occurrence of the malfunction of a touch panel including the adhesive layer. In particular, the temperature dependency of a specific dielectric constant is more preferably less than or equal to 20%, is even more preferably less than or equal to 15%, and is particularly preferably less than or equal to 10%, from the viewpoint of less occurrence of the malfunction of the touch panel. The lower limit is not particularly limited, but it is preferable that the lower limit becomes lower, and it is most preferable that the lower limit is 0%.

A performing method of the temperature dependency evaluation test will be described below in detail. Furthermore, the measurement of a specific dielectric constant using an impedance measurement technology at each temperature described below is generally referred to as a capacitance method. The capacitance method is conceptually a method in which a condenser is formed by interposing a sample between electrodes, and a dielectric constant is calculated from the measured capacitance value. In addition, an electronic device such as a touch panel is inevitably used in the outdoor as the ubiquitous society is matured along with the mobilization of an electronic device on which an electrostatic capacitance type touch panel is mounted, and thus, an environment temperature at which the electronic device is exposed is assumed to −40° C. to 80° C., and in this evaluation test, a temperature of −40° C. to 80° C. is set to a test environment.

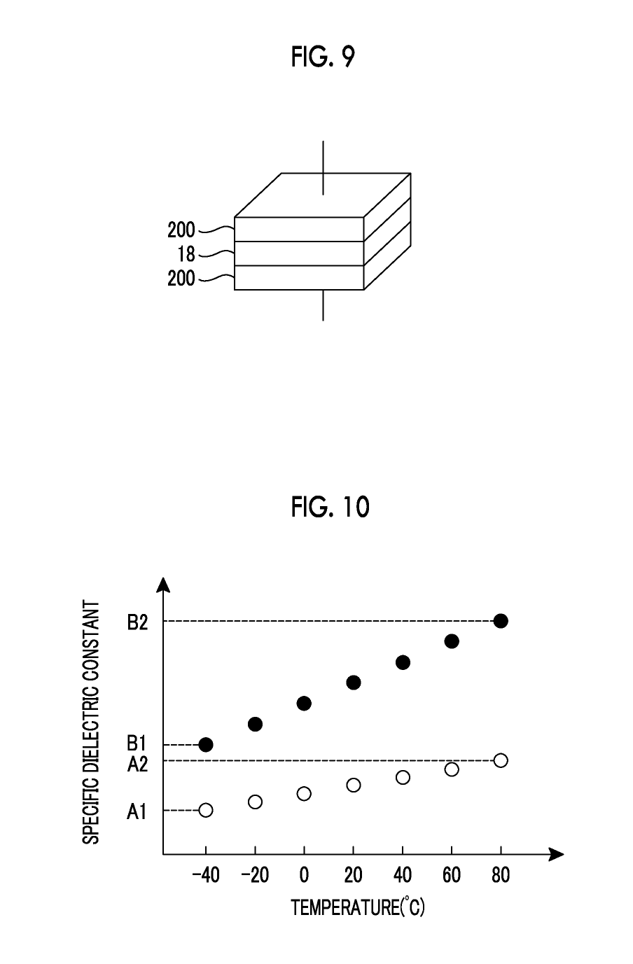

First, as illustrated in FIG. 9, the adhesive layer 18 which is a measurement target (Thickness: 100 μm to 500 μm) is interposed between a pair of aluminum electrodes 200 (Electrode Area: 20 mm×20 mm), and a pressure defoaming treatment is performed at a temperature of 40° C. and a pressure of 5 atm for 60 minutes, and thus, a sample for evaluation is prepared.

After that, the temperature of the adhesive layer in the sample gradually rises from −40° C. to 80° C. by 20° C., and electrostatic capacitance C is obtained at each temperature by impedance measurement at 1 MHz using an impedance analyzer (4294A manufactured by Agilent Technologies). After that, the obtained electrostatic capacitance C and a thickness T of the adhesive layer are multiplied together, and then, the obtained value is divided by a product of an area S of the aluminum electrode and a vacuum dielectric constant ∈₀ (8.854×10⁻¹² F/m), and thus, the specific dielectric constant is calculated.

That is, the specific dielectric constant is calculated by Expression (X): Specific Dielectric Constant=(Electrostatic Capacitance C×Thickness T)/(Area S×Vacuum Dielectric Constant ∈₀).

More specifically, the temperature of the adhesive layer gradually rises such that the temperature becomes −40° C., −20° C., 0° C., 20° C., 40° C., 60° C., and 80° C., the adhesive layer is left to stand at each temperature for 5 minutes until the temperature of the adhesive layer becomes stable, and the electrostatic capacitance C is obtained by the impedance measurement at the temperature and 1 MHz, and thus, the specific dielectric constant at each temperature is calculated from the obtained value.

Furthermore, the thickness of the adhesive layer is a value obtained by measuring the thicknesses of arbitrary points of greater than or equal to 5 of the adhesive layer, and by arithmetically averaging the measured thicknesses.

After that, the minimum value and the maximum value are selected from the calculated specific dielectric constants, and the ratio of a difference between the minimum value and the maximum value to the minimum value is obtained. More specifically, a value (%) calculated by Expression [{(Maximum Value−Minimum Value)/Minimum Value}×100] is obtained, and the value is set to the temperature dependency.

In FIG. 10, an example of a temperature dependency evaluation test result is illustrated. Furthermore, in FIG. 10, a horizontal axis indicates a temperature, and a vertical axis indicates a specific dielectric constant. In addition, FIG. 10 is an example of the measurement results of two types of adhesive layers, and illustrates the result of one adhesive layer by a white circle, and the result of the other adhesive layer by a black circle.

With reference to FIG. 10, in an adhesive layer A illustrated by a white circle, the specific dielectric constants at each temperature are comparatively close to each other, and a change thereof is also small. That is, the specific dielectric constant of the adhesive layer A has small change according to a temperature, and the specific dielectric constant of the adhesive layer A is rarely changed even in a cold district and a warm district. As a result thereof, in a touch panel including the adhesive layer A, the electrostatic capacitance between detection electrodes is rarely shifted from a value which is initially set, and thus, malfunction rarely occurs. Furthermore, temperature dependency (%) of the adhesive layer A is able to be obtained from Expression [(A2−A1)/A1×100] by selecting A1 which is the minimum value of the white circles in FIG. 2 and A2 which is the maximum value.

In contrast, in an adhesive layer B illustrated by a black circle, the specific dielectric constant considerably increases as the temperature rises, and thus, a change thereof is large. That is, the specific dielectric constant of the adhesive layer B has a large change according to a temperature, the electrostatic capacitance between the detection electrodes is easily shifted from a value which is initially set, and thus, malfunction easily occurs. Furthermore, temperature dependency (%) of the adhesive layer B is able to be obtained from Expression [(B2−B1)/B1×100] by selecting B1 which is the minimum value of the black circles in FIGS. 2 and B2 which is the maximum value.

That is, the temperature dependency described above indicates the degree of the change in the dielectric constants according to a temperature, and the specific dielectric constant is rarely changed from a low temperature (−40° C.) to a high temperature (80° C.) as the value of the temperature dependency decreases. In contrast, the specific dielectric constant is easily changed from a low temperature (−40° C.) to a high temperature (80° C.) as the value of the temperature dependency decreases.

(Manufacturing Procedure of Adhesive Layer)

A method of obtaining the adhesive layer by photocuring the composition described above is not particularly limited, and a known method is adopted. Examples of the method include a method in which a composition is applied onto a predetermined substrate (for example, a peeling sheet), and as necessary, is subjected to a drying treatment, and is photocured by light irradiation, and thus, an adhesive layer (an adhesive sheet) is formed. Furthermore, after the adhesive sheet is formed, the peeling sheet may be laminated on the adhesive sheet surface. In addition, adhesive layer may be formed by applying the composition onto the peeling sheet, by further laminating a peeling sheet on a coated film, and by performing light irradiation in a state where the coated film is interposed between the peeling sheets.

Examples of a method of applying the composition include a gravure coater, a comma coater, a bar coater, a knife coater, a die coater, a roll coater, and the like.

The conditions of a light irradiation treatment are not particularly limited, but an ultraviolet ray irradiation method is preferable in which an ultraviolet ray is generated, and the composition is photocured by being irradiated with the ultraviolet ray. Examples of an ultraviolet ray lamp to be used in such a method include a metal halide lamp, a high pressure mercury lamp, a low pressure mercury lamp, a pulse type xenon lamp, a xenon/mercury mixed lamp, a low pressure sterilizing lamp, and an electrodeless lamp. Among the ultraviolet ray lamps, it is preferable that the metal halide lamp or the high pressure mercury lamp is used.

In addition, the irradiation conditions are different according to the conditions of each lamp, and in general, an irradiation exposure amount may be in a range of 20 mJ/cm² to 10,000 mJ/cm², and is preferably in a range of 100 mJ/cm² to 3,000 mJ/cm².

A method of obtaining the laminate for a touch panel is not particularly limited, and examples of the method include a method of obtaining the laminate for a touch panel by bonding the adhesive layer (the adhesive sheet) manufactured as described above onto the conductive portion side of the laminate comprising the resin substrate and the conductive portion.

Furthermore, it is preferable that a heat treatment is performed after the adhesive layer is bonded. By performing the heat treatment, the adhesiveness between the resin substrate and the adhesive layer is further improved.

The conditions of the heat treatment are not particularly limited, and a heating temperature is preferably 30° C. to 80° C., and is more preferably 40° C. to 60° C., and a heating time is preferably 5 minutes to 60 minutes, and is more preferably 15 minutes to 30 minutes.

In addition, at the time of performing bonding, as necessary, pressurization may be performed. The conditions of the pressurization are not particularly limited, but it is preferable that the pressurization is performed under conditions of a pressure of 2 atm to 10 atm.

<Another Embodiment of Laminate for Touch Panel>

In FIG. 1, the first embodiment of the laminate for a touch panel has been described in detail, but the configuration of the laminate for a touch panel is not limited to this embodiment.

In FIG. 1, an embodiment is illustrated in which the conductive portion 16 and the adhesive layer 18 are disposed on one surface of the resin substrate 12, and the laminate for a touch panel of the present invention may comprise the conductive portion 16 and the adhesive layer 18 on both sides of the resin substrate 12. In a case of this embodiment, the adhesive layers 18 on both surfaces of the resin substrate 12 satisfy the requirements (A) and (B) described above.

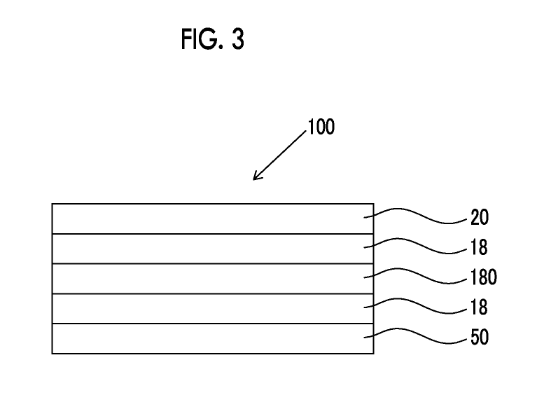

In addition, the laminate for a touch panel is applied to an electrostatic capacitance type touch panel. In a case where the laminate for a touch panel is applied to the touch panel, the resin substrate 12 and the conductive portion 16 described above function as a part of an electrostatic capacitance type touch sensor. More Specifically, as illustrated in FIG. 3, an electrostatic capacitance type touch panel 100 comprises a protective substrate 20, the adhesive layer (the adhesive sheet) 18, an electrostatic capacitance type touch panel sensor 180, the adhesive layer (the adhesive sheet) 18, and a display device 50, as a preferred embodiment of the electrostatic capacitance type touch panel including the laminate for a touch panel described above. As described below, the electrostatic capacitance type touch panel sensor 180 includes the resin substrate 12, and a first detection electrode and a second detection electrode which correspond to the conductive portion 16.

Hereinafter, various members to be used in the electrostatic capacitance type touch panel 100 will be described in detail.

[Electrostatic Capacitance Type Touch Panel Sensor]

The electrostatic capacitance type touch panel sensor 180 is a sensor which is arranged on a display device (an operator side) and detects the position of an external conductor such as a human finger by using a change in electrostatic capacitance generated at the time of being in contact with (close to) the external conductor such as the human finger.

The configuration of the electrostatic capacitance type touch panel sensor 180 is not particularly limited, and in general, the electrostatic capacitance type touch panel sensor 180 includes a detection electrode (in particular, a detection electrode extending in an X direction and a detection electrode extending in a Y direction), and a change in the electrostatic capacitance of the detection electrode which is in contact with or close to the finger is detected, and thus, the coordinates of the finger is specified.

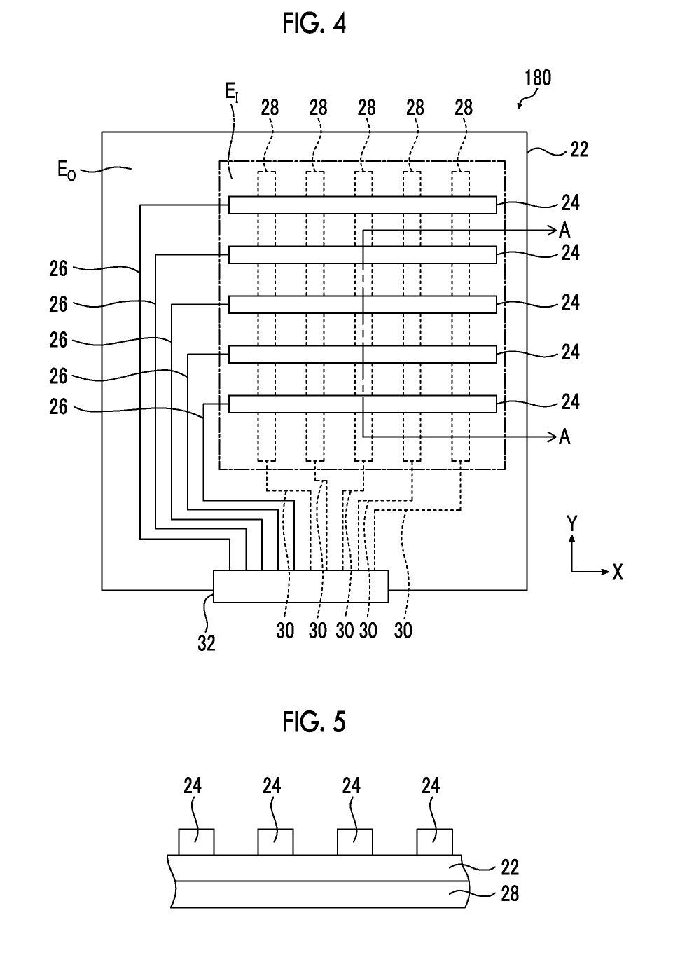

In FIG. 4, a plan view of the electrostatic capacitance type touch panel sensor 180 is illustrated. FIG. 5 is a sectional view cut along cutting line A-A of FIG. 4. The electrostatic capacitance type touch panel sensor 180 comprises a resin substrate 22, a first detection electrode 24 arranged on one main surface (on the surface) of the resin substrate 22, first lead-out wiring 26, a second detection electrode 28 arranged on the other main surface (on the back surface) of the resin substrate 22, second lead-out wiring 30, and a flexible printed wiring board 32. Furthermore, a region including the first detection electrode 24 and the second detection electrode 28 configures an input region E_{I} in which an input operation is able to be detected by a user (an input region (a sensing unit) in which the contact of an object is able to be detected), and the first lead-out wiring 26, the second lead-out wiring 30, and the flexible printed wiring board 32 are arranged in an outside region E_{O} which is positioned on the outside of the input region E_{I}.

Hereinafter, the configuration described above will be described in detail.

The resin substrate 22 has a function of supporting the first detection electrode 24 and the second detection electrode 28 in the input region E_{I}, and also has a function of supporting the first lead-out wiring 26 and the second lead-out wiring 30 in the outside region E_{O}.

The definition and a preferred embodiment of the resin substrate 22 are identical to those of the resin substrate 12 described above.

The first detection electrode 24 and the second detection electrode 28 are sensing electrodes sensing a change in the electrostatic capacitance, and configure a sensor unit. That is, in a case where a finger tip is in contact with the touch panel, mutual electrostatic capacitance between the first detection electrode 24 and the second detection electrode 28 is changed, and the position of the finger tip is calculated by an IC circuit on the basis of the amount of change.

The first detection electrode 24 has a function of detecting the input position of the finger of a user close to the input region E_{I} in the X direction, and has a function of generating electrostatic capacitance between the first detection electrode 24 and the finger. The first detection electrode 24 is an electrode which extends in a first direction (the X direction) and is arranged in a second direction (the Y direction) orthogonal to the first direction at a predetermined interval, and includes a predetermined pattern described below.

The second detection electrode 28 has a function of detecting the input position of the finger of the user close to the input region E_{I} in the Y direction, and has a function of generating electrostatic capacitance between the second detection electrode 28 and the finger. The second detection electrode 28 is an electrode which extends in the second direction (the Y direction), and is arranged in the first direction (the X direction) at a predetermined interval, and includes a predetermined pattern described below. In FIG. 4, five first detection electrodes 24 and five second detection electrodes 28 are disposed, but the number of detection electrodes is not particularly limited, and a plurality of detection electrodes may be disposed.

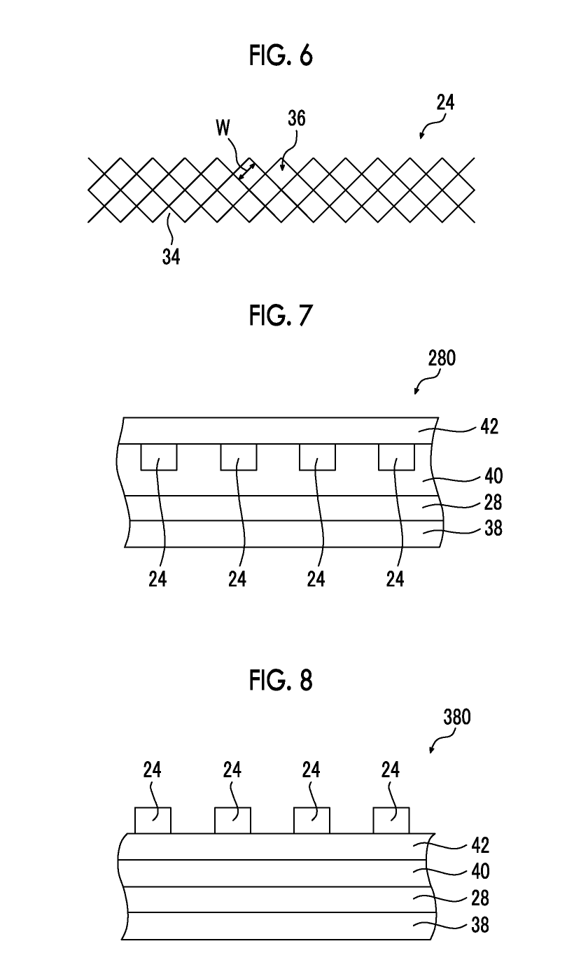

In FIG. 4, the first detection electrode 24 and the second detection electrode 28 are configured of a metal thin wire. In FIG. 6, a partial enlarged plan view of the first detection electrode 24 is illustrated. As illustrated in FIG. 6, the first detection electrode 24 is configured of a metal thin wire 34, and includes a plurality of opening portions 36 formed by intersecting metal thin wires 34. Furthermore, as with the first detection electrode 24, the second detection electrode 28 also includes a plurality of opening portions 36 formed by intersecting metal thin wires 34. That is, the first detection electrode 24 and the second detection electrode 28 correspond to a conductive portion having a mesh pattern which is formed of a plurality of metal thin wires described above.

The first detection electrode 24 and the second detection electrode 28 correspond to the conductive portion 16 described above, and has a mesh pattern formed of a plurality of metal thin wires. The definition and a preferred embodiment of the metal thin wire 34 configuring the first detection electrode 24 and the second detection electrode 28 are identical to those of the metal thin wire 14 described above. In addition, the definition of the opening portion 36 is as described above.

The first lead-out wiring 26 and the second lead-out wiring 30 are members having a function of applying a voltage to each of the first detection electrode 24 and the second detection electrode 28 described above.

The first lead-out wiring 26 is arranged on the resin substrate 22 in the outside region E_{O}, one end of the first lead-out wiring 26 is electrically connected to the corresponding first detection electrode 24, and the other end is electrically connected to the flexible printed wiring board 32.

The second lead-out wiring 30 is arranged on the resin substrate 22 in the outside region E_{O}, one end of the second lead-out wiring 30 is electrically connected to the corresponding second detection electrode 28, and the other end is electrically connected to the flexible printed wiring board 32.

Furthermore, in FIG. 4, five first lead-out wirings 26 and five second lead-out wirings 30 are disposed, but the number of lead-out wirings is not particularly limited, and in general, a plurality of lead-out wirings are arranged according to the number of detection electrodes.

Examples of the material configuring the first lead-out wiring 26 and the second lead-out wiring 30 include metal such as gold (Au), silver (Ag), and copper (Cu), a metal oxide such as tin oxide, zinc oxide, cadmium oxide, gallium oxide, and titanium oxide, and the like. Among them, the silver is preferable from the viewpoint of excellent conductivity. In addition, the material configuring the first lead-out wiring 26 and the second lead-out wiring 30 may be prepared by using a metal paste such as a silver paste or a copper paste. Further, the material configuring the first lead-out wiring 26 and the second lead-out wiring 30 may be configured of metal such as aluminum (Al) or molybdenum (Mo) or an alloy thin film. In a case of the metal paste, a screen printing method or ink jet printing method is preferably used, and in a case of the metal or the alloy thin film, a patterning method such as a photolithography method which patterns a sputtered film is preferably used.

Furthermore, it is preferable that a binder is contained in the first lead-out wiring 26 and the second lead-out wiring 30 from the viewpoint of excellent adhesiveness between the lead-out wiring and the resin substrate 22. The type of binder is as described above.

The flexible printed wiring board 32 is a plate in which a plurality of wirings and terminals are disposed on a substrate, and is connected to the other end of each of the first lead-out wirings 26 and the other end of each of the second lead-out wirings 30, and thus, has a function of connecting the electrostatic capacitance type touch panel sensor 180 to an external device (for example, a display device).

[Manufacturing Method of Electrostatic Capacitance Type Touch Panel Sensor]

A manufacturing method of the electrostatic capacitance type touch panel sensor 180 is not particularly limited, and a known method is able to be adopted. Examples of the manufacturing method include a method in which a photoresist film on a metal foil formed on both main surfaces of the resin substrate 22 is exposed, a resist pattern is formed by performing a development treatment, and the metal foil exposed from the resist pattern is etched. In addition, examples of the manufacturing method include a method in which a paste including metal fine particles or a metal nanowire is printed on both main surfaces of the resin substrate 22, and the paste is subjected to metal plating. In addition, examples of the manufacturing method also include a method of performing printing formation with respect to the resin substrate 22 by using a screen printing plate or a gravure plate, or a method using an ink jet.

Further, examples of the manufacturing method also include a method using silver halide in addition to the methods described above. More specifically, examples of the manufacturing method also include a method including a step (1) of forming a silver halide emulsion layer containing silver halide and a binder (hereinafter, also simply referred to as a photosensitive layer) on each of both surfaces of the resin substrate 22, and a step (2) of performing a development treatment after exposing the photosensitive layer.

Hereinafter, each step will be described.

<Step (1): Photosensitive Layer Formation Step>

The step (1) is a step of forming the photosensitive layer containing the silver halide and the binder on both surfaces of the resin substrate 22.

A method of forming the photosensitive layer is not particularly limited, but a method is preferable in which a composition for forming a photosensitive layer containing silver halide and a binder is brought into contact with the resin substrate 22, and thus, the photosensitive layer is formed on both surfaces of the resin substrate 22, from the viewpoint of the productivity.

Hereinafter, an embodiment of the composition for forming a photosensitive layer to be used in by the method described above will be described in detail, and then, the procedure of the steps will be described in detail.

The composition for forming a photosensitive layer contains the silver halide and the binder.

A halogen element contained in the silver halide may be any one of chlorine, bromine, iodine, and fluorine, or may be a combination thereof. For example, silver halide containing silver chloride, silver bromide, and silver iodide as a main component is preferably used as the silver halide, and silver halide containing silver bromide or silver chloride as a main component is more preferably used.

The type of binder to be used is as described above. In addition, the binder may be contained in the composition for forming a photosensitive layer in the form of a latex.

A volume ratio of the silver halide and the binder contained in the composition for forming a photosensitive layer is not particularly limited, and is suitably adjusted to be the preferred range of the volume ratio of the metal and the binder in the metal thin wire 34 described above.

The composition for forming a photosensitive layer, as necessary, contains a solvent.

Examples of the solvent to be used are able to include water, an organic solvent (for example, alcohols such as methanol, ketones such as acetone, amides such as formamide, sulfoxides such as dimethyl sulfoxide, esters such as ethyl acetate, ethers, and the like), an ionic liquid, a mixed solvent thereof, and the like.

The content of the solvent to be used is not particularly limited, but is preferably in a range of 30 mass % to 90 mass %, and is more 50 mass % to 80 mass %, with respect to the total mass of the silver halide and the binder.

(Procedure of Step)

A method of bringing the composition for forming a photosensitive layer into contact with the resin substrate 22 is not particularly limited, and a known method is able to be adopted. Examples of the method include a method of applying the composition for forming a photosensitive layer onto the resin substrate 22, a method of dipping the resin substrate 22 in the composition for forming a photosensitive layer, and the like.

The content of the binder in the formed photosensitive layer is not particularly limited, but is preferably 0.3 g/m² to 5.0 g/m², and is more preferably 0.5 g/m² to 2.0 g/m².

In addition, the content of the silver halide in the photosensitive layer is not particularly limited, but is preferably 1.0 g/m² to 20.0 g/m², and is more preferably 5.0 g/m² to 15.0 g/m², in terms of silver, from the viewpoint of more excellent conductive properties of the metal thin wire 34.

Furthermore, as necessary, a protective layer formed of a binder may be further disposed on the photosensitive layer. By disposing the protective layer, scratch prevention or dynamic properties are improved.

<Step (2): Exposure Development Step>

The step (2) is a step of forming the first detection electrode 24 and the first lead-out wiring 26, and the second detection electrode 28 and the second lead-out wiring 30 by performing pattern exposure with respect to the photosensitive layer obtained in the step (1) described above, and then, by performing a development treatment.

Hereinafter, first, a pattern exposure treatment will be described in detail, and then, the development treatment will be described in detail.

(Pattern Exposure)

The photosensitive layer is exposed into the shape of a pattern, and thus, the silver halide in the photosensitive layer forms a latent image in an exposed region. The region in which the latent image is formed forms a metal thin wire by the development treatment described below. On the other hand, in an unexposed region which is not exposed, the silver halide is dissolved and flows out from the photosensitive layer at the time of performing the fixing treatment described below, and thus, a transparent film is obtained.

A light source to be used at the time of performing exposure is not particularly limited, and examples of the light source include light such as a visible light ray and an ultraviolet ray, radiation such as an X ray, and the like.

A method of performing the pattern exposure is not particularly limited, and for example, surface exposure using a photomask may be performed, or scanning exposure using a laser beam may be performed. Furthermore, the shape of the pattern is not particularly limited, and is suitably adjusted according to the pattern of a metal thin wire which is planned to be formed.

(Development Treatment)

A method of performing the development treatment is not particularly limited, and a known method is able to be adopted. For example, a technology of a general development treatment to be used in a silver salt photographic film, photographic paper, a printing plate making film, an emulsion mask for a photomask, and the like is able to be used.

The type of a developer to be used at the time of performing the development treatment is not particularly limited, and for example, a PQ developer, an MQ developer, an MAA developer, and the like are able to be used. For example, a developer such as CN-16, CR-56, CP45X, FD-3, and PAPITOL which are manufactured by Fujifilm Corporation, and C-41, E-6, RA-4, D-19, and D-72 which are manufactured by Kodak Company, or a developer contained in a kit thereof is able to be used as a commercially available product. In addition, a lith developer is able to be used.

The development treatment is able to include a fixing treatment which is performed in order to obtain stabilization by removing the silver salt in the unexposed portion. The fixing treatment is able to use a technology of a fixing treatment to be used in a silver salt photographic film, photographic paper, a printing plate making film, an emulsion mask for a photomask, and the like.

The fixing temperature in a fixing step is preferably approximately 20° C. to approximately 50° C., and is more preferably 25° C. to 45° C. In addition, a fixing time is preferably 5 seconds to 1 minute, and is more preferably 7 seconds to 50 seconds.

The ratio of the mass of the metal silver contained in an exposed portion (the metal thin wire) after the development treatment is preferably greater than or equal to 50 mass %, and is more preferably greater than or equal to 80 mass %, with respect to the mass of the silver contained in the exposed portion before the exposure. It is preferable that the ratio of the mass of the silver contained in the exposed portion is greater than or equal to 50 mass % with respect to the mass of the silver contained in the exposed portion before the exposure since high conductivity is able to be obtained.

As necessary, an undercoat layer formation step, an antihalation layer formation step, a heat treatment, or a de-binder treatment described below may be performed, in addition to the steps described above.

(Undercoat Layer Formation Step)

It is preferable that a step of forming an undercoat layer containing the predetermined compound described above on the surface of the resin substrate 22 is performed before the step (1) described above, from the viewpoint of excellent adhesiveness between the resin substrate 22 and the silver halide emulsion layer.

The compound to be used is as described above.

(Antihalation Layer Formation Step)

It is preferable that a step of forming an antihalation layer on both surfaces of the resin substrate 22 is performed before the step (1) described above, from the viewpoint of making the metal thin wire 34 thin.

<Step (3): Heating Step>

A step (3) is performed as necessary, and is a step in which a heat treatment is performed after the development treatment described above. By performing this step, fusion occurs between binders or the hardness of the metal thin wire 34 further increases. In particular, in a case where polymer particles are dispersed as the binder in the composition for forming a photosensitive layer (in a case where the binders are polymer particles in a latex), fusion occurs between the polymer particles or the metal thin wire 34 exhibiting desired hardness is formed by performing this step.

Preferred conditions are suitably selected according to a binder to be used as the conditions of the heat treatment, and it is preferable that the heat treatment is performed at a temperature of higher than or equal to 40° C. from the viewpoint of the film formation temperature of the polymer particles, and the temperature of the heat treatment is more preferably higher than or equal to 50° C., and is even more preferably higher than or equal to 60° C. In addition, the temperature of the heat treatment is preferably lower than or equal to 150° C., and is more preferably lower than or equal to 100° C., from the viewpoint of suppressing curling of the substrate or the like.

A heating time is not particularly limited, but is preferably 1 minute to 5 minutes, and is more 1 minute to 3 minutes, from the viewpoint of suppressing the curling of the substrate or the like and from the viewpoint of the productivity.

Furthermore, in general, this heat treatment is preferable since the heat treatment is able to function as a drying step which is performed after the exposure treatment and the development treatment, and thus, it is not necessary to add a new step for forming a film of the polymer particles, from the viewpoint of excellent productivity and costs.

<Step (4): De-Binder Treatment Step>

The de-binder treatment step is a step of further treating a resin substrate including a metal thin wire with a proteolytic enzyme decomposing a water-soluble binder such as gelatin, or an oxidant such as an oxo acid. By performing this step, the water-soluble binder such as the gelatin is decomposed and removed from the photosensitive layer which has been subjected to the exposure treatment and the development treatment, and ion migration between the metal thin wires is suppressed.

Hereinafter, first, a material to be used in this step will be described in detail, and then, the procedure of this step will be described in detail.

(Proteolytic Enzyme)

An enzyme known as a vegetable or animal enzyme which is able to hydrolyze protein such as gelatin is used as the proteolytic enzyme (hereinafter, also referred to as an enzyme). Examples of the proteolytic enzyme include pepsin, rennin, trypsin, chymotrypsin, cathepsin, papain, phycin, thrombin, renin, collagenase, bromelain, bacterial protease, and the like. Among them, the trypsin, the papain, phycin, and the bacterial protease are particularly preferable. Among them, in particular, the bacterial protease (for example, BIOPRASE manufactured by NAGASE & CO., LTD.) is commercially available at a low price, and thus, is easily available.

(Oxidant)

An oxidant known as an oxidant which is able to perform oxidation decomposition with respect to the protein such as the gelatin is used as the oxidant. Examples of the oxidant include a halogen oxoate such as a hypochlorite, a chlorite, and a chlorate. Among them, a sodium hypochlorite is commercially available at a low price, and thus, is easily available.

(Reduction Treatment)

It is preferable that a reduction treatment is performed in combination since in a case where the gelatin is decomposed by the oxidant, the metal of the metal thin wire is oxidized, and thus, electrical resistance increases. The reduction treatment is not particularly limited insofar as the type of reduction aqueous solution is able to allow the silver to be reduced, and for example, an aqueous solution of sodium disulfite, an aqueous solution of hydroquinone, an aqueous solution of paraphenylene diamine, an aqueous solution of an oxalic acid, an aqueous solution of an ascorbic acid, an aqueous solution of sodium borohydride, and the like are able to be used, and it is more preferable that pH of the aqueous solution is greater than or equal to 10.

A treatment method is not particularly limited, and the resin substrate including the metal thin wire may be in contact with the reduction aqueous solution. Examples of a contact method include a method of dipping a support in the reduction aqueous solution.

By performing the reduction treatment, the conductivity further increases, and thus, even in a case where the gelatin is not decomposed by the oxidant, the gelatin is able to be preferably used.

(Procedure of Step)

The procedure of the de-binder treatment step is not particularly limited insofar as the resin substrate including the metal thin wire and the enzyme or the oxidant described above are able to be in contact with each other. Examples of a contact method include a method of applying a treatment liquid onto the resin substrate including the metal thin wire, a method of dipping the resin substrate including the metal thin wire in the treatment liquid, and the like.

The content of the enzyme in the treatment liquid is not particular defined, and is able to be arbitrarily determined according to the performance which is required as the capability of the enzyme to be used. In particular, the content of the enzyme is preferably approximately 0.05 mass % to 20 mass %, and is more preferably 5 mass % to 10 mass %, with respect to the total amount of the treatment liquid, from the viewpoint of easily controlling the degree of decomposing and removing the gelatin.

The treatment liquid is able to contain a pH buffer, an antibacterial compound, a wetting agent, a preservative, and the like, as necessary, in addition to the enzyme described above.

pH of the treatment liquid is selected according to a test such that the operation of the enzyme is maximally obtained, and in general, is preferably 5 to 7. In addition, the temperature of the treatment liquid is also a temperature at which the operation of the enzyme is improved, and specifically, is preferably 25° C. to 45° C.

A contact time is not particularly limited, but is preferably 10 seconds to 500 seconds, and is more preferably 90 seconds to 360 seconds, from the viewpoint of more excellent ion migration suppressing capacity of the conductive portion.

Furthermore, as necessary, a step of washing the resin substrate including the metal thin wire with warm water may be further included after the treatment is performed by using the treatment liquid. By including this step, a gelatin decomposition residue, a residue of the proteolytic enzyme, a residual oxidant, or the like is able to be removed, and the ion migration is further suppressed.

A washing method is not particularly limited, the resin substrate including the metal thin wire and the warm water may be able to be in contact with each other, and examples of the washing method include a method of dipping the resin substrate including the metal thin wire in the warm water, a method of applying the warm water onto the resin substrate including the metal thin wire, and the like.

An optimum temperature is suitably selected as the temperature of the warm water according to the type of proteolytic enzyme to be used, and is preferably 20° C. to 80° C., and is more preferably 40° C. to 60° C., from the viewpoint of the productivity.

A contact time (a washing time) between the warm water and the resin substrate including the metal thin wire is not particularly limited, but is preferably 1 second to 600 seconds, and is more preferably 30 seconds to 360 seconds, from the viewpoint of the productivity.

In addition, as necessary, a smoothing treatment may be performed with respect to the obtained resin substrate including the metal thin wire after the treatment described above. A method of the smoothing treatment is not particularly limited, and for example, the smoothing treatment is able to be performed by using a calender roll. In general, the calender roll is formed of a pair of rolls.

[Protective Substrate]

The protective substrate 20 is a substrate which is arranged on the adhesive sheet and has a function of protecting the electrostatic capacitance type touch panel sensor 180 described below from the external environment, and the main surface thereof configures a touch surface.

A transparent substrate is preferable as the protective substrate 20, and a plastic film, a plastic plate, a glass plate, and the like are used as the protective substrate 20. It is desirable that the thickness of each substrate is suitably selected according to the application.

For example, polyesters such as polyethylene terephthalate (PET) and polyethylene naphthalate (PEN); polyolefins such as polyethylene (PE), polypropylene (PP), polystyrene, and EVA; a vinyl-based resin; polycarbonate (PC), polyamide, polyimide, an acrylic resin, triacetyl cellulose (TAC), a cycloolefin-based resin (COP), and the like are able to be used as the raw material of the plastic film and the plastic plate described above.

In addition, a polarizing plate, circularly polarizing plate, and the like may be used as the protective substrate 20.

[Display Device]

The display device 50 is a device including a display surface which displays an image, and each member is arranged on a display screen side.

The type of display device 50 is not particularly limited, and a known display device is able to be used. Examples of the display device 50 include a cathode ray tube (CRT) display device, a liquid crystal display device (LCD), an organic light emitting diode (OLED) display device, a vacuum fluorescent display (VFD), a plasma display panel (PDP), a surface electric field display (SED) or an electric field emission display (FED), electronic paper (E-Paper), and the like.

Furthermore, in addition to the above description, the laminate for a touch panel of the present invention is able to be applied as a part of another embodiment of the electrostatic capacitance type touch panel sensor.

For example, as illustrated in FIG. 7, an electrostatic capacitance type touch panel sensor 280 comprises a first substrate 38, a second detection electrode 28 arranged on the first substrate 38, second lead-out wiring (not illustrated) which is electrically connected to one end of the second detection electrode 28 and is arranged on the first substrate 38, an adhesive sheet 40, a first detection electrode 24, first lead-out wiring (not illustrated) which is electrically connected to one end of the first detection electrode 24, a second substrate 42 to which the first detection electrode 24 and the first lead-out wiring are close, and a flexible printed wiring board (not illustrated).

As illustrated in FIG. 7, the electrostatic capacitance type touch panel sensor 280 has the same configuration as that of the electrostatic capacitance type touch panel sensor 180 except for the first substrate 38, the second substrate 42, and the adhesive sheet 40, and thus, the same numerical numbers are applied to the same constituents, and the description thereof will be omitted.

The definition of the first substrate 38 and the second substrate 42 is identical to the definition of the resin substrate 22 described above.

In FIG. 7, a plurality of first detection electrodes 24 and the second detection electrodes 28 may be respectively used as illustrated in FIG. 4, and both of the first detection electrodes 24 and the second detection electrodes 28 are arranged to intersect with each other as illustrated in FIG. 4.

In the electrostatic capacitance type touch panel sensor 280, the first substrate 38 (or the second substrate 42) corresponds to the resin substrate 22 described above, the second detection electrode 28 (or the first detection electrode 24) corresponds to the conductive portion 16, and the adhesive sheet 40 corresponds to the adhesive layer 18.

Examples of another embodiment of the electrostatic capacitance type touch panel sensor include an embodiment illustrated in FIG. 8.

An electrostatic capacitance type touch panel sensor 380 comprises the first substrate 38, the second detection electrode 28 arranged on the first substrate 38, the second lead-out wiring (not illustrated) which is electrically connected to one end of the second detection electrode 28 and is arranged on the first substrate 38, the adhesive sheet 40, the second substrate 42, the first detection electrode 24 arranged on the second substrate 42, the first lead-out wiring (not illustrated) which is electrically connected to one end of the first detection electrode 24 and is arranged on the second substrate 42, and the flexible printed wiring board (not illustrated).

The electrostatic capacitance type touch panel sensor 380 illustrated in FIG. 8 has the same configuration as that of the electrostatic capacitance type touch panel sensor 280 illustrated in FIG. 7 except that the order of each layer is different, and thus, the same numerical numbers are applied to the same constituents, and the description thereof will be omitted.

In addition, in FIG. 8, a plurality of first detection electrodes 24 and the second detection electrodes 28 may be respectively used as illustrated in FIG. 4, and both of the first detection electrodes 24 and the second detection electrodes 28 are arranged to intersect with each other as illustrated in FIG. 4.

In the electrostatic capacitance type touch panel sensor 380, the first substrate 38 corresponds to the resin substrate 22 described above, the second detection electrode 28 corresponds to the conductive portion 16, and the adhesive sheet 40 corresponds to the adhesive layer 18.

### EXAMPLES

Hereinafter, the present invention will be described in detail by examples, but the present invention is not limited thereto.

### Synthesis Example 1

19.6 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 11.9 parts by mass of polybutadiene (Product Name: Poluvest110, manufactured by Evonik Japan Co., Ltd.), 18 parts by mass of isobornyl acrylate (manufactured by Tokyo Chemical Industry Co., Ltd.), 5 parts by mass of 2-ethyl hexyl acrylate (manufactured by Wako Pure Chemical Industries, Ltd.), 2 parts by mass of glycidyl methacrylate (manufactured by Wako Pure Chemical Industries, Ltd.), and 38.8 parts by mass of a hydrogenated terpene-based resin (Product Name CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 1.7 parts by mass of 1-dodecane thiol (DDT, manufactured by Tokyo Chemical Industry Co., Ltd.) and 3 parts by mass of a photopolymerization initiator (Product Name: Lucirin TPO, manufactured by BASF SE) were put into the thermostatic tank and were stirred by the stirrer, and thus, an adhesive 1 was prepared.

The obtained adhesive 1 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1 J/cm², and thus, an adhesive sheet 1 was obtained.

### Synthesis Example 2

An adhesive sheet 2 was obtained according to the same procedure as that in Synthesis Example 1 except that the glycidyl methacrylate was changed to CYCLOMER A-200 (manufactured by Daicel Corporation).

### Synthesis Example 3

An adhesive sheet 3 was obtained according to the same procedure as that in Synthesis Example 1 except that the glycidyl methacrylate was changed to CYCLOMER M-100 (manufactured by Daicel Corporation).

### Synthesis Example 4

7 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 22 parts by mass of polybutadiene (Product Name: Poluvest110, manufactured by Evonik Japan Co., Ltd.), 15.5 parts by mass of isobornyl acrylate (manufactured by Tokyo Chemical Industry Co., Ltd.), 5 parts by mass of 2-ethyl hexyl acrylate (manufactured by Wako Pure Chemical Industries, Ltd.), 2.5 parts by mass of dodecyl acrylate (manufactured by Wako Pure Chemical Industries, Ltd.), 2 parts by mass of glycidyl methacrylate (manufactured by Wako Pure Chemical Industries, Ltd.), and 43 parts by mass of a hydrogenated terpene-based resin (Product Name: CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 3 parts by mass of a photopolymerization initiator (Product Name: Lucirin TPO, manufactured by BASF SE) was put into the thermostatic tank and were stirred by the stirrer, and thus, an adhesive 4 was prepared.

The obtained adhesive 4 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1 J/cm², and thus, an adhesive sheet 4 was obtained.

### Synthesis Example 5

An adhesive sheet 5 was obtained according to the same procedure as that in Synthesis Example 4 except that the glycidyl methacrylate was changed to CYCLOMER A-200 (manufactured by Daicel Corporation).

### Synthesis Example 6

An adhesive sheet 6 was obtained according to the same procedure as that in Synthesis Example 4 except that the glycidyl methacrylate was changed to CYCLOMER M-100 (manufactured by Daicel Corporation).

### Synthesis Example 7

7 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 22 parts by mass of polybutadiene (Product Name: Poluvest110, manufactured by Evonik Japan Co., Ltd.), 17.5 parts by mass of isobornyl acrylate (manufactured by Tokyo Chemical Industry Co., Ltd.), 5 parts by mass of 2-ethyl hexyl acrylate (manufactured by Wako Pure Chemical Industries, Ltd.), 2.5 parts by mass of dodecyl acrylate (manufactured by Wako Pure Chemical Industries, Ltd.), 0.5 parts by mass of CELLOXIDE 2021P (manufactured by Daicel Corporation), and 43 parts by mass of a hydrogenated terpene-based resin (Product Name: CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 3 parts by mass of a photopolymerization initiator (Product Name: Lucirin TPO, manufactured by BASF SE) was put into the thermostatic tank and were stirred by the stirrer, and thus, an adhesive 7 was prepared.

The obtained adhesive 7 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1 J/cm², and thus, an adhesive sheet 7 was obtained.

### Synthesis Example 8

19.6 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 11.9 parts by mass of polybutadiene (Product Name: Poluvest110, manufactured by Evonik Japan Co., Ltd.), 19 parts by mass of isobornyl acrylate (manufactured by Tokyo Chemical Industry Co., Ltd.), 5 parts by mass of 2-ethyl hexyl acrylate (manufactured by Wako Pure Chemical Industries, Ltd.), 1 part by mass of glycidyl methacrylate (manufactured by Wako Pure Chemical Industries, Ltd.), and 38.8 parts by mass of a hydrogenated terpene-based resin (Product Name: CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 1.7 parts by mass of 1-dodecane thiol (DDT, manufactured by Tokyo Chemical Industry Co., Ltd.) and 3 parts by mass of a photopolymerization initiator (Product Name: Lucirin TPO, manufactured by BASF SE) were put into the thermostatic tank and were stirred by the stirrer, and thus, an adhesive 8 was prepared.

The obtained adhesive 8 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1 J/cm², and thus, an adhesive sheet 8 was obtained.

### Synthesis Example 9

27 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 5.4 parts by mass of polybutadiene (Product Name: Poluvest110, manufactured by Evonik Japan Co., Ltd.), 20 parts by mass of isobornyl acrylate (manufactured by Tokyo Chemical Industry Co., Ltd.), 5 parts by mass of 2-ethyl hexyl acrylate (manufactured by Wako Pure Chemical Industries, Ltd.), and 37 parts by mass of a hydrogenated terpene-based resin (Product Name: CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 2.6 parts by mass of 1-dodecane thiol (DDT, manufactured by Tokyo Chemical Industry Co., Ltd.) and 3 parts by mass of a photopolymerization initiator (Product Name: Lucirin TPO, manufactured by BASF SE) were put into the thermostatic tank and were stirred by the stirrer, and thus, an adhesive 9 was prepared.

The obtained adhesive 9 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1.5 J/cm², and thus, an adhesive sheet 9 was obtained.

### Synthesis Example 10

19.6 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 11.9 parts by mass of polybutadiene (Product Name: Poluvest110, manufactured by Evonik Japan Co., Ltd.), 18 parts by mass of isobornyl acrylate (manufactured by Tokyo Chemical Industry Co., Ltd.), 5 parts by mass of 2-ethyl hexyl acrylate (manufactured by Wako Pure Chemical Industries, Ltd.), 2 parts by mass of CYCLOMER A-200 (manufactured by Daicel Corporation), and 38.8 parts by mass of a hydrogenated terpene-based resin (Product Name: CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 1.7 parts by mass of 1-dodecane thiol (DDT, manufactured by Tokyo Chemical Industry Co., Ltd.) and 3 parts by mass of a photopolymerization initiator (Product Name: Lucirin TPO, manufactured by BASF SE) were put into the thermostatic tank and were stirred by the stirrer, and thus, an adhesive 10 was prepared.

The obtained adhesive 10 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1.5 J/cm², and thus, an adhesive sheet 10 was obtained.

### Synthesis Example 11

19.6 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 10.9 parts by mass of polybutadiene (Product Name: Poluvest110, manufactured by Evonik Japan Co., Ltd.), 18 parts by mass of isobornyl acrylate (manufactured by Tokyo Chemical Industry Co., Ltd.), 5 parts by mass of 2-ethyl hexyl acrylate (manufactured by Wako Pure Chemical Industries, Ltd.), 2 parts by mass of CYCLOMER A-200 (manufactured by Daicel Corporation), and 38.8 parts by mass of a hydrogenated terpene-based resin (Product Name: CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 1.7 parts by mass of 1-dodecane thiol (DDT, manufactured by Tokyo Chemical Industry Co., Ltd.) and 4 parts by mass of a photopolymerization initiator (Product Name: Lucirin TPO, manufactured by BASF SE) were put into the thermostatic tank and were stirred by the stirrer, and thus, an adhesive 11 was prepared.

The obtained adhesive 11 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1 J/cm², and thus, an adhesive sheet 11 was obtained.

### Synthesis Example 12

An adhesive sheet 12 was obtained according to the same procedure as that in Synthesis Example 1 except that the glycidyl methacrylate of Example 1 was changed to KARENZ MOI (manufactured by SHOWA DENKO K.K.).

### Synthesis Example 13

An adhesive sheet 13 was obtained according to the same procedure as that in Synthesis Example 1 except that the glycidyl methacrylate of Example 1 was changed to KBM503 (manufactured by Shin-Etsu Chemical Co., Ltd.).

### Synthesis Example 14

19.6 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 10.7 parts by mass of polybutadiene (Product Name: Poluvest110, manufactured by Evonik Japan Co., Ltd.), 18 parts by mass of isobornyl acrylate (manufactured by Tokyo Chemical Industry Co., Ltd.), 5 parts by mass of 2-ethyl hexyl acrylate (manufactured by Wako Pure Chemical Industries, Ltd.), 2 parts by mass of glycidyl methacrylate (manufactured by Wako Pure Chemical Industries, Ltd.), and 40 parts by mass of a hydrogenated terpene-based resin (Product Name: CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 1.7 parts by mass of 1-dodecane thiol (DDT, manufactured by Tokyo Chemical Industry Co., Ltd.) and 3 parts by mass of a photopolymerization initiator (Product Name: Lucirin TPO, manufactured by BASF SE) were put into the thermostatic tank and were stirred by the stirrer, and thus, an adhesive 14 was prepared.

The obtained adhesive 14 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1 J/cm², and thus, an adhesive sheet 14 was obtained.

### Synthesis Example 15

31.1 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 15.9 parts by mass of polybutadiene (Product Name: Poluvest110, manufactured by Evonik Japan Co., Ltd.), 11 parts by mass of isobornyl acrylate (manufactured by Tokyo Chemical Industry Co., Ltd.), 2 parts by mass of 2-ethyl hexyl acrylate (manufactured by Wako Pure Chemical Industries, Ltd.), 2 parts by mass of glycidyl methacrylate (manufactured by Wako Pure Chemical Industries, Ltd.), and 34 parts by mass of a hydrogenated terpene-based resin (Product Name: CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 1 part by mass of 1-dodecane thiol (DDT, manufactured by Tokyo Chemical Industry Co., Ltd.) and 3.0 parts by mass of a photopolymerization initiator (Product Name: Lucirin TPO, manufactured by BASF SE) were put into the thermostatic tank and were stirred by the stirrer, and thus, an adhesive 15 was prepared.

The obtained adhesive 15 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1 J/cm², and thus, an adhesive sheet 15 was obtained.

### Synthesis Example 16

10.2 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 15.9 parts by mass of polybutadiene (Product Name: Poluvest110, manufactured by Evonik Japan Co., Ltd.), 20 parts by mass of isobornyl acrylate (manufactured by Tokyo Chemical Industry Co., Ltd.), 25 parts by mass of 2-ethyl hexyl acrylate (manufactured by Wako Pure Chemical Industries, Ltd.), 2 parts by mass of glycidyl methacrylate (manufactured by Wako Pure Chemical Industries, Ltd.), and 20 parts by mass of a hydrogenated terpene-based resin (Product Name: CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 3.9 parts by mass of 1-dodecane thiol (DDT, manufactured by Tokyo Chemical Industry Co., Ltd.) and 3 parts by mass of a photopolymerization initiator (Product Name: Lucirin TPO, manufactured by BASF SE) were put into the thermostatic tank and were stirred by the stirrer, and thus, an adhesive 16 was prepared.

The obtained adhesive 16 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1 J/cm², and thus, an adhesive sheet 16 was obtained.

### Synthesis Example 17

12.5 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 26.3 parts by mass of polybutadiene (Product Name: Poluvest110, manufactured by Evonik Japan Co., Ltd.), 30 parts by mass of isobornyl acrylate (manufactured by Tokyo Chemical Industry Co., Ltd.), 3 parts by mass of 2-ethyl hexyl acrylate (manufactured by Wako Pure Chemical Industries, Ltd.), 2 parts by mass of glycidyl methacrylate (manufactured by Wako Pure Chemical Industries, Ltd.), and 20 parts by mass of a hydrogenated terpene-based resin (Product Name: CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 3.2 parts by mass of 1-dodecane thiol (DDT, manufactured by Tokyo Chemical Industry Co., Ltd.) and 3 parts by mass of a photopolymerization initiator (Product Name: Lucirin TPO, manufactured by BASF SE) were put into the thermostatic tank and were stirred by the stirrer, and thus, an adhesive 17 was prepared.

The obtained adhesive 17 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1 J/cm², and thus, an adhesive sheet 17 was obtained.

### Synthesis Example 18

12.5 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 19.3 parts by mass of polybutadiene (Product Name: Poluvest110, manufactured by Evonik Japan Co., Ltd.), 25 parts by mass of isobornyl acrylate (manufactured by Tokyo Chemical Industry Co., Ltd.), 3 parts by mass of 2-ethyl hexyl acrylate (manufactured by Wako Pure Chemical Industries, Ltd.), 2 parts by mass of glycidyl methacrylate (manufactured by Wako Pure Chemical Industries, Ltd.), and 32 parts by mass of a hydrogenated terpene-based resin (Product Name: CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 3.2 parts by mass of 1-dodecane thiol (DDT, manufactured by Tokyo Chemical Industry Co., Ltd.) and 3 parts by mass of a photopolymerization initiator (Product Name: Lucirin TPO, manufactured by BASF SE) were put into the thermostatic tank and were stirred by the stirrer, and thus, an adhesive 18 was prepared.

The obtained adhesive 18 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1 J/cm², and thus, an adhesive sheet 18 was obtained.

### Synthesis Example 19

16.5 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 10 parts by mass of polybutadiene (Product Name: Poluvest110, manufactured by Evonik Japan Co., Ltd.), 8 parts by mass of isobornyl acrylate (manufactured by Tokyo Chemical Industry Co., Ltd.), 13 parts by mass of 2-ethyl hexyl acrylate (manufactured by Wako Pure Chemical Industries, Ltd.), 2 parts by mass of glycidyl methacrylate (manufactured by Wako Pure Chemical Industries, Ltd.), and 46 parts by mass of a hydrogenated terpene-based resin (Product Name: CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 1.5 parts by mass of 1-dodecane thiol (DDT, manufactured by Tokyo Chemical Industry Co., Ltd.) and 3 parts by mass of a photopolymerization initiator (Product Name: Lucirin TPO, manufactured by BASF SE) were put into the thermostatic tank and were stirred by the stirrer, and thus, an adhesive 19 was prepared.

The obtained adhesive 19 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1 J/cm², and thus, an adhesive sheet 19 was obtained.

### Synthesis Example 20

18 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 8.9 parts by mass of polybutadiene (Product Name: Poluvest110, manufactured by Evonik Japan Co., Ltd.), 1 part by mass of isobornyl acrylate (manufactured by Tokyo Chemical Industry Co., Ltd.), 17 parts by mass of 2-ethyl hexyl acrylate (manufactured by Wako Pure Chemical Industries, Ltd.), 2 parts by mass of glycidyl methacrylate (manufactured by Wako Pure Chemical Industries, Ltd.), and 49 parts by mass of a hydrogenated terpene-based resin (Product Name: CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 1.1 parts by mass of 1-dodecane thiol (DDT, manufactured by Tokyo Chemical Industry Co., Ltd.) and 3 parts by mass of a photopolymerization initiator (Product Name: Lucirin TPO, manufactured by BASF SE) were put into the thermostatic tank and were stirred by the stirrer, and thus, an adhesive 20 was prepared.

The obtained adhesive 20 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1 J/cm², and thus, an adhesive sheet 20 was obtained.

### Comparative Synthesis Example 1

22 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 11 parts by mass of polybutadiene (Product Name: Poluvest110, manufactured by Evonik Japan Co., Ltd.), 20 parts by mass of isobornyl acrylate (manufactured by Tokyo Chemical Industry Co., Ltd.), 5 parts by mass of 2-ethyl hexyl acrylate (manufactured by Wako Pure Chemical Industries, Ltd.), and 38.8 parts by mass of a hydrogenated terpene-based resin (Product Name: CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 3 parts by mass of a photopolymerization initiator (Product Name: Lucirin TPO, manufactured by BASF SE) was put into the thermostatic tank and were stirred by the stirrer, and thus, an adhesive 21 was prepared.

The obtained adhesive 21 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1 J/cm², and thus, an adhesive sheet 21 was obtained.

### Comparative Synthesis Example 2

19.6 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 11.9 parts by mass of polybutadiene (Product Name: Poluvest110, manufactured by Evonik Japan Co., Ltd.), 20 parts by mass of isobornyl acrylate (manufactured by Tokyo Chemical Industry Co., Ltd.), 5 parts by mass of 2-ethyl hexyl acrylate (manufactured by Wako Pure Chemical Industries, Ltd.), and 38.8 parts by mass of a hydrogenated terpene-based resin (Product Name: CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 1.7 parts by mass of 1-dodecane thiol (DDT, manufactured by Tokyo Chemical Industry Co., Ltd.) and 3 parts by mass of a photopolymerization initiator (Product Name: Lucirin TPO, manufactured by BASF SE) were put into the thermostatic tank and were stirred by the stirrer, and thus, an adhesive 22 was prepared.

The obtained adhesive 22 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1 J/cm², and thus, an adhesive sheet 22 was obtained.

### Comparative Synthesis Example 3

19.6 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 11.9 parts by mass of polybutadiene (Product Name: Poluvest110, manufactured by Evonik Japan Co., Ltd.), 18 parts by mass of isobornyl acrylate (manufactured by Tokyo Chemical Industry Co., Ltd.), 5 parts by mass of 2-ethyl hexyl acrylate (manufactured by Wako Pure Chemical Industries, Ltd.), 2 parts by mass of isobutyl methacrylate (IBMA) (manufactured by Wako Pure Chemical Industries, Ltd.), and 38.8 parts by mass of a hydrogenated terpene-based resin (Product Name: CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 1.7 parts by mass of 1-dodecane thiol (DDT, manufactured by Tokyo Chemical Industry Co., Ltd.) and 3 parts by mass of a photopolymerization initiator (Product Name: Lucirin TPO, manufactured by BASF SE) were put into the thermostatic tank and were stirred by the stirrer, and thus, an adhesive 23 was prepared.

The obtained adhesive 23 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1 J/cm², and thus, an adhesive sheet 23 was obtained.

### Comparative Synthesis Example 4

19.6 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 11.9 parts by mass of polybutadiene (Product Name: Poluvest110, manufactured by Evonik Japan Co., Ltd.), 18 parts by mass of isobornyl acrylate (manufactured by Tokyo Chemical Industry Co., Ltd.), 5 parts by mass of 2-ethyl hexyl acrylate (manufactured by Wako Pure Chemical Industries, Ltd.), 2 parts by mass of 2-ethyl hexyl glycidyl ether (EHGE) (manufactured by Wako Pure Chemical Industries, Ltd.), and 38.8 parts by mass of a hydrogenated terpene-based resin (Product Name: CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 1.7 parts by mass of 1-dodecane thiol (DDT, manufactured by Tokyo Chemical Industry Co., Ltd.) and 3 parts by mass of a photopolymerization initiator (Product Name: Lucirin TPO, manufactured by BASF SE) were put into the thermostatic tank and were stirred by the stirrer, and thus, an adhesive 24 was prepared.

The obtained adhesive 24 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1 J/cm², and thus, an adhesive sheet 24 was obtained.

### Comparative Synthesis Example 5

19.6 parts by mass of an esterification product of a maleic anhydride adduct of a polyisoprene polymerization product and 2-hydroxy ethyl methacrylate (Product Name: UC102, manufactured by KURARAY CO., LTD., and a molecular weight of 19,000), 0.7 parts by mass of polybutadiene (Product Name: Poluvest110, manufactured by Evonik Japan Co., Ltd.), 20 parts by mass of isobornyl acrylate (manufactured by Tokyo Chemical Industry Co., Ltd.), 5 parts by mass of 2-ethyl hexyl acrylate (manufactured by Wako Pure Chemical Industries, Ltd.), and 50 parts by mass of a hydrogenated terpene-based resin (Product Name: CLEARON P-135, manufactured by YASUHARA CHEMICAL CO., LTD.) were stirred by a stirrer in a thermostatic tank at 130° C., and subsequently, the temperature of the thermostatic tank was adjusted to be 80° C., 1.7 parts by mass of 1-dodecane thiol (DDT, manufactured by Tokyo Chemical Industry Co., Ltd.) and 3 parts by mass of a photopolymerization initiator (Product Name: Lucirin TPO, manufactured by BASF SE) were put into the thermostatic tank and were stirred by the stirrer, and thus, an adhesive 25 was prepared.

The obtained adhesive 25 was applied onto the surface-treated surface of a peeling sheet having a thickness of 75 μm to have a thickness of 100 μm, and the surface-treated surface of a peeling sheet having a thickness of 50 μm was bonded onto the coating liquid. A sample interposed between the peeling sheets was irradiated with UV light by using a metal halide UV lamp (manufactured by Heraeus K.K.) such that irradiation energy became 1 J/cm², and thus, an adhesive sheet 25 was obtained.

<Moisture-Heat Adhesion Force Evaluation>

Each adhesive sheet (a thickness of 100 μm) obtained as described above was cut to have a size of 25 mm×40 mm, one surface thereof was bonded to a solid sample (30 mm×50 mm) described below in a width direction, the other surface was bonded to a polyimide sheet (KAPTON 100H, a width of 30 mm, a length of 120 mm, and a thickness of 25 μm) in the width direction, and a pressure defoaming treatment was performed at 40° C. and a pressure of 5 atm for 60 minutes. After that, the adhesive sheet was left to stand at room temperature (approximately 23° C.) for one day, and thus, a sample for adhesion force evaluation was prepared. After that, the sample was set in a TENSILON device provided with a thermostatic tank such that one end of the polyimide sheet which was not in contact with the adhesive layer was pulled out (peeled off) in a direction of 180 degrees, the thermostatic tank was left to stand in an environment of a temperature of 85° C. and humidity of 85% for 30 minutes, and in this environment (a temperature of 85° C. and humidity of 85%), a 180-degree peeling test was performed at a speed of 300 mm/sec.

<Modulus of Elasticity Evaluation>

An adhesive sheet and a resin substrate which had a width of 5 mm, a length of 25 mm, and a thickness of 200 μm were used as a sample, were set in a device (DVA-225 manufactured by IPROS CORPORATION) having a distance between chucks of 20 mm, and were left to stand in an environment of a temperature of 85° C. and humidity of 85% for 1 hour, and in this environment (a temperature of 85° C. and humidity of 85%), evaluation was performed at a measurement frequency of 1 Hz in a pulling mode based on JIS K7244.

Furthermore, a sample was prepared by superposing two sheets of 100 μm which were manufactured in the examples and the comparative examples described above, as a test sample of the adhesive sheet.

<Expansion Factor Evaluation>

As a measurement method of the thermal expansion factor of the adhesive sheet and the resin substrate described above, measurement was performed on the basis of JIS K7197. Specifically, a test sample having a length of 30 mm, a width of 5 mm, and a thickness of 800 μm was set in a compressing mode, and a thermal expansion change at a temperature of 25° C. to 85° C. in a thickness direction was measured in conditions of a temperature rising rate of 2° C./min by using a thermomechanical measurement device TMA-60 manufactured by Shimadzu Corporation. Furthermore, a sample was prepared by superposing eight sheets of 100 μm which were manufactured in the examples and the comparative examples described above, as a test sample of the adhesive sheet.

<Manufacturing of Laminate Including Resin Substrate and Conductive Portion>

(Preparation of Silver Halide Emulsion)

A second liquid and a third liquid described below were respectively added into a first liquid described below which was retained at a temperature of 38° C. and pH of 4.5 for 20 minutes in the amount corresponding to 90% while being stirred, and thus, core particles of 0.16 μm were formed. Subsequently, a fourth liquid and a fifth liquid described below were added thereinto for 8 minutes, the remaining amount of 10% of the second liquid and the third liquid described below was further added thereinto for 2 minutes, and growth was performed until the diameter of the core particles became 0.21 μm. Further, 0.15 g of potassium iodide was added thereinto, maturing was performed for 5 minutes, and the formation of the particles was finished.

<First Liquid>

| | | |
|---|---|---|
| Water | 750 | m |
| Gelatin | 8.6 | g |
| Sodium Chloride | 3.1 | g |
| 1,3-Dimethyl Imidazolidine-2-Thione | 20 | mg |
| Sodium Benzene Thiosulfonic Acid | 10 | mg |
| Citric Acid | 0.7 | g |

<Second Liquid>

| | | |
|---|---|---|
| Water | 300 | ml |
| Silver Nitrate | 150 | g |

<Third Liquid>

| | | |
|---|---|---|
| Water | 300 | ml |
| Sodium Chloride | 38 | g |
| Potassium Bromide | 32 | g |
| Potassium Hexachloroiridate (III) (20% | 5 | ml |
| of Aqueous Solution of KCl of 0.005%) | | |
| Ammonium Hexachlorinated Rhodiumate | 7 | ml |
| (20% of Aqueous Solution of NaCl of | | |
| 0.001%) | | |

<Fourth Liquid>

| | | |
|---|---|---|
| Water | 100 | ml |
| Silver Nitrate | 50 | g |

<Fifth Liquid>

| | | |
|---|---|---|
| Water | 100 | ml |
| Sodium Chloride | 13 | g |
| Potassium Bromide | 11 | g |
| Yellow Prussiate | 5 | mg |

After that, washing was performed by a flocculation method according to a normal method. Specifically, a temperature was lowered to 35° C., and pH was lowered by using a sulfuric acid (pH was in a range of 3.6±0.2) until silver halide was precipitated. Next, approximately 3 liters of a supernatant was removed (first washing). Further, 3 liters of distilled water was added thereinto, and then, a sulfuric acid was added until the silver halide was precipitated. 3 liters of the supernatant was removed again (second washing). The same operation as that of the second washing was further repeated once (third washing), and washing and desalination step was finished. An emulsion after the washing and desalination was adjusted such that pH was 6.3 and pAg was 7.4, 2.5 g of gelatin, 10 mg of a sodium benzene thiosulfonic acid, 3 mg of a sodium benzene sulfinate, 15 mg of sodium thiosulfate, and 10 mg of a chloroauric acid were added, chemical sensitization was performed such that optimum sensitivity was obtained at 55° C., and 100 mg of 1,3,3a,7-tetraazaindene as a stabilizer and 100 mg of PROXEL (Product Name, manufactured by ICI Co., Ltd.) as a preservative were added. The finally obtained emulsion was a silver iodine chlorobromide cubic particle emulsion having an average particle diameter of 0.21 μm and a variation coefficient of 9.5% in which 0.08 mol % of silver iodide was contained, and the ratio of silver chlorobromide was set such that the ratio of silver chloride was 70 mol %, and the ratio of silver bromide was 30 mol %.

(Preparation Composition for Forming Photosensitive Layer)

1.2×10⁻⁴ mol/mol Ag of 1,3,3a,7-tetraazaindene, 1.2×10⁻² mol/mol Ag of hydroquinone, 3.0×10⁻⁴ mol/mol Ag of a citric acid, 0.90 g/mol Ag of a 2,4-dichloro-6-hydroxy-1,3,5-triazine sodium salt, and a slight amount of curing agent were added into the emulsion described above, and pH of a coating liquid was adjusted to be 5.6 by using a citric acid.

A dispersant formed of a polymer denoted by (P-1) described below and dialkyl phenyl PEO sulfuric acid ester was added with respect to the gelatin contained in the coating liquid described above. Furthermore, the added amount of a crosslinking agent was adjusted such that the amount of crosslinking agent in a silver halide-containing photosensitive layer described below became 0.09 g/m². As described above, a composition for forming a photosensitive layer was prepared.

Furthermore, the polymer denoted by (P-1) was synthesized with reference to JP3305459B and JP3754745B.

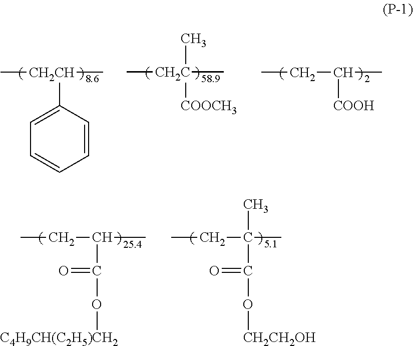

(Photosensitive Layer Formation Step)

A polymer latex containing the dispersant formed of the polymer denoted by (P-1) exemplified as described above and the dialkyl phenyl PEO sulfuric acid ester (the mass ratio of the dispersant/the polymer of 2.0/100 was 0.02) was applied onto a polyethylene terephthalate (PET) film (Thermal Expansion Factor: 150 ppm/° C.) of 100 μm, and thus, an undercoat layer having a thickness of 0.05 μm was disposed.

Next, a composition for forming a layer not containing silver halide in which the polymer latex and the gelatin described above were mixed was applied onto the undercoat layer, and thus, a layer not containing silver halide having a thickness of 1.0 μm was disposed. Furthermore, the mixed mass ratio of the polymer and the gelatin (the polymer/the gelatin) was 2/1, and the content of the polymer was 0.65 g/m². Furthermore, the thermal expansion factor of a laminate including the PET film, the undercoat layer, and the layer not containing silver halide described above was at the same degree as that of the thermal expansion factor of the PET film.

Next, the composition for forming a photosensitive layer described above was applied onto the layer not containing silver halide, and thus, a silver halide-containing photosensitive layer having a thickness of 2.5 μm was disposed. Furthermore, the content of the polymer in the silver halide-containing photosensitive layer was 0.22 g/m².

Next, a composition for forming a protective layer in which the polymer latex and the gelatin described above were mixed was applied onto the silver halide-containing photosensitive layer, and thus, a protective layer having a thickness of 0.15 μm was disposed. Furthermore, the mixed mass ratio of the polymer and the gelatin (the polymer/the gelatin) was 0.1/1, and the content of the polymer was 0.015 g/m².

(Exposure and Development Treatment)

Exposure was performed with respect to the silver halide-containing photosensitive layer prepared as described above through a photomask in the shape of a square lattice providing a conductive pattern as illustrated in FIG. 2 in which a plurality of square lattices having a width Wa of a metal thin wire/a width Wb of an opening portion of 4.0 μm/296 μm were arranged by parallel light using a high pressure mercury lamp as a light source (hereinafter, suitably referred to as a mesh pattern electrode). As illustrated in FIG. 2, the line width Wa of the metal thin wire 14 configuring the square lattice was 4 μm, and a distance between the metal thin wire 14 of the square lattice (the length of one side of the opening portion) was 296 μm. That is, the arrangement pitch of a mesh in the mesh pattern was 300 μm.

Development was performed by using a developer described below after the exposure, and a fixing treatment was performed by using a fixing liquid (Product Name: N3X-R for CN16X: manufactured by Fujifilm Corporation), and then, rinsing was performed by using pure water, and after that, drying was performed, and thus, a sample including a mesh pattern electrode having a thickness tc of 2.5 μm (hereinafter, referred to as a mesh sample) was obtained.

Further, the silver halide-containing photosensitive layer prepared as described above was not subjected to the exposure, and was subjected to the same development, the same fixing, the same rinsing, and the same drying treatment as those described above, and thus, a sample not including a metal layer (hereinafter, referred to as a solid sample) was prepared in order to perform moisture-heat adhesion force measurement.

(Composition of Developer)

Compounds described below are contained in 1 liter (L) of the developer.

| | |
|---|---|
| Hydroquinone | 0.037 mol/L |
| N-Methyl Aminophenol | 0.016 mol/L |
| Sodium Metaborate | 0.140 mol/L |
| Sodium Hydroxide | 0.360 mol/L |
| Sodium Bromide | 0.031 mol/L |
| Potassium Metabisulfite | 0.187 mol/L |

(Gelatin Decomposition Treatment)

The obtained mesh sample and solid sample were dipped in an aqueous solution (Concentration of Proteolytic Enzyme: 0.5 mass %, and Liquid Temperature: 40° C.) of a proteolytic enzyme (BIOPRASE AL-15FG, manufactured by Nagase ChemteX Corporation) for 120 seconds. The mesh sample and the solid sample were respectively taken out from the aqueous solution, were dipped in warm water (Liquid Temperature: 50° C.) for 120 seconds, and were washed.

(Reduction Treatment)

The mesh sample and the solid sample were dipped in a reduction treatment liquid described below for 360 seconds, were washed with pure water after being dipped, and were dried.

<Composition of Reduction Treatment Liquid>

Compounds described below are contained in 1 liter (L) of the reduction treatment liquid.

| | |
|---|---|
| Hydroquinone | 0.20 mol/L |
| Potassium Hydroxide | 0.45 mol/L |
| Potassium Carbonate | 0.24 mol/L |

(Calender Treatment)

A metal plate (a stainless steel plate) having a surface shape in which Ra was 0.28 μm, and Sm was 1.87 μm was used as a mat member for a calender treatment, a mesh sample having a width of 6 cm was placed on the metal plate, a jack pressure of 11.4 MPa was applied by using a calender device in which a metal roller (a diameter of 95 mm) and a resin roller (a diameter of 95 mm) having a mirror finished surface were combined, and transport was performed at a speed of 120 mm/minute, and thus, a calender treatment was performed. Similarly, the solid sample was also subjected to the calender treatment.

(Heat Treatment)

The mesh sample and the solid sample were treated in a superheated vapor tank at 120° C. for 130 seconds. Accordingly, the mesh sample and the solid sample was obtained.

Furthermore, the mesh sample comprises a polyethylene terephthalate (PET) film, and a mesh pattern electrode (Width of Metal Thin Wire: 4 μm, and Width of Opening Portion: 296 μm) arranged on one surface of the PET film.

### Examples and Comparative Examples

The peeling sheet arranged on one surface of the adhesive sheet obtained in each of Synthesis Examples 1 to 20 and Comparative Synthesis Examples 1 to 5 described above was peeled off, and the adhesive sheet described above was bonded onto the mesh pattern electrode of the mesh sample described above by using a roller having a weight of 2 kg. Next, the peeling sheet arranged on the other surface was further peeled off, and the adhesive sheet described above was bonded onto a glass substrate or a resin film (for example, PET) having the same size as that of the adhesive layer by using a roller having a weight of 2 kg. After that, exposure was performed in a high pressure thermostatic tank in an environment of a temperature of 40° C. and a pressure of 5 atm for 20 minutes, and a defoaming treatment was performed, and thus, a laminate for a touch panel was obtained.

<Disconnection Evaluation>

The obtained laminate for a touch panel was left to stand under an environment of a temperature of 85° C. and humidity of 85% for 1 hour. After that, the laminate for a touch panel after being left to stand for 1 hour was observed by a microscope, and arbitrary 50 metal thin wires were observed, and thus, the disconnection and the positional shift of the metal thin wire from the state of the laminate for a touch panel before being left to stand under the environment of a temperature of 85° C. and humidity of 85% described above for 1 hour were evaluated on the basis of the following criteria.

“A”: A case where the disconnection of the metal thin wire does not occur, and the positional shift is less than 5 μm

“B”: A case where the disconnection of the metal thin wire does not occur, and the positional shift is greater than or equal to 5 μm and less than 20 μm

“C”: A case where the disconnection of the metal thin wire does not occur, and the positional shift was greater than or equal to 20 μm and less than 75 μm

“D”: A case where the disconnection of the metal thin wire does not occur, and the positional shift was greater than or equal to 75 μm

“E”: A case where the disconnection of the metal thin wire occurs

<Temperature Dependency Evaluation>

One peeling sheet on the surface of the adhesive sheet prepared in the example was peeled off, the exposed adhesive sheet (Thickness: 100 μm) was bonded onto an aluminum electrode having a height of 20 mm×a width of 20 mm, and a thickness of 0.5 mm, and then, the other peeling sheet was peeled off, the aluminum electrode described above was bonded onto the exposed adhesive sheet, and after that, a pressure defoaming treatment was performed at a temperature of 40° C. and a pressure of 5 atm for 60 minutes, and thus, a sample for a temperature dependency evaluation test was prepared.

Furthermore, the thickness of the adhesive sheet in each sample was calculated by measuring the thicknesses of five portions in the sample for a temperature dependency evaluation test using a micrometer, and by subtracting the thickness of two aluminum electrodes from the average value of the thicknesses of the five portions.

Impedance measurement was performed at 1 MHz by an impedance analyzer (4294A manufactured by Agilent Technologies) using the sample for a temperature dependency evaluation test prepared as described above, and thus, the specific dielectric constant of the adhesive sheet was measured.

Specifically, the sample for a temperature dependency evaluation test gradually rose from −40° C. to 80° C. by 20° C., and electrostatic capacitance C was obtained at each temperature by the impedance measurement at 1 MHz using the impedance analyzer (4294A manufactured by Agilent Technologies). Furthermore, the sample was left to stand at each temperature for 5 minutes until the temperature of the sample became stable.

After that, the specific dielectric constant at each temperature was calculated from Expression (X) described below by using the obtained electrostatic capacitance C.

Specific Dielectric Constant=(Electrostatic Capacitance C×Thickness T)/(Area S×Vacuum Dielectric Constant ∈₀) Expression (X):

Furthermore, the thickness T indicates the thickness of the adhesive sheet, the area S indicates the area of the aluminum electrode (a height of 20 mm×a width of 20 mm), and the vacuum dielectric constant ∈₀ indicates a physical constant (8.854×10⁻¹² F/m).

The minimum value and the maximum value were selected from the calculated specific dielectric constants, and thus, temperature dependency (%) (Δc %) was obtained from Expression [{(Maximum Value−Minimum Value)/Minimum Value}×100].

Furthermore, in a case of a low temperature, the temperature was adjusted by using a liquid nitrogen cooling stage, and in a case of a high temperature, the temperature was adjusted by using a hot plate.

<Malfunction Evaluation Method>

First, a manufacturing method of a touch panel used in a malfunction evaluation method will be described.

(Preparation of Silver Halide Emulsion)

A second liquid and a third liquid described below were respectively added into a first liquid described below which was retained at a temperature of 38° C. and pH of 4.5 for 20 minutes in the amount corresponding to 90% while being stirred, and thus, core particles of 0.16 μm were formed. Subsequently, a fourth liquid and a fifth liquid described below were added thereinto for 8 minutes, the remaining amount of 10% of the second liquid and the third liquid described below was further added thereinto for 2 minutes, and growth was performed until the diameter of the core particles became 0.21 μm. Further, 0.15 g of potassium iodide was added thereinto, maturing was performed for 5 minutes, and the formation of the particles was finished.

First Liquid:

| | | |
|---|---|---|
| Water | 750 | ml |
| Gelatin | 9 | g |
| Sodium Chloride | 3 | g |
| 1,3-Dimethyl Imidazolidine-2-Thione | 20 | mg |
| Sodium Benzene Thiosulfonic Acid | 10 | mg |
| Citric Acid | 0.7 | g |

Second Liquid:

| | | |
|---|---|---|
| Water | 300 | ml |
| Silver Nitrate | 150 | g |

Third Liquid:

| | | |
|---|---|---|
| Water | 300 | ml |
| Sodium Chloride | 38 | g |
| Potassium Bromide | 32 | g |
| Potassium Hexachloroiridate (III) (20% | 8 | ml |
| of Aqueous Solution of KCl of 0.005%) | | |
| Ammonium Hexachlorinated Rhodiumate | 10 | ml |
| (20% of Aqueous Solution of NaCl of | | |
| 0.001%) | | |

Fourth Liquid:

| | | |
|---|---|---|
| Water | 100 | ml |
| Silver Nitrate | 50 | g |

Fifth Liquid:

| | | |
|---|---|---|
| Water | 100 | ml |
| Sodium Chloride | 13 | g |
| Potassium Bromide | 11 | g |
| Yellow Prussiate | 5 | mg |

After that, washing was performed by a flocculation method according to a normal method. Specifically, a temperature was lowered to 35° C., and pH was lowered by using a sulfuric acid (pH was in a range of 3.6±0.2) until silver halide was precipitated. Next, approximately 3 liters of a supernatant was removed (first washing). Further, 3 liters of distilled water was added thereinto, and then, a sulfuric acid was added until the silver halide was precipitated. 3 liters of the supernatant was removed again (second washing). The same operation as that of the second washing was further repeated once (third washing), and washing and desalination step was finished. An emulsion after the washing and desalination was adjusted such that pH was 6.4 and pAg was 7.5, 3.9 g of gelatin, 10 mg of a sodium benzene thiosulfonic acid, 3 mg of a sodium benzene sulfinate, 15 mg of a sodium thiosulfate, and 10 mg of a chloroauric acid were added, chemical sensitization was performed such that optimum sensitivity was obtained at 55° C., and 100 mg of 1,3,3a,7-tetraazaindene as a stabilizer and 100 mg of PROXEL (Product Name, manufactured by ICI Co., Ltd.) as a preservative were added. The finally obtained emulsion was a silver iodine chlorobromide cubic particle emulsion having an average particle diameter of 0.22 μm and a variation coefficient of 9% in which 0.08 mol % of silver iodide was contained, and the ratio of silver chlorobromide was set such that the ratio of silver chloride was 70 mol %, and the ratio of silver bromide was 30 mol %.

(Preparation Composition for Forming Photosensitive Layer)

1.2×10⁻⁴ mol/mol Ag of 1,3,3a,7-tetraazaindene, 1.2×10⁻² mol/mol Ag of hydroquinone, 3.0×10⁻⁴ mol/mol Ag of a citric acid, 0.90 g/mol Ag of a 2,4-dichloro-6-hydroxy-1,3,5-triazine sodium salt, and a slight amount of curing agent were added into the emulsion described above, and pH of a coating liquid was adjusted to be 5.6 by using a citric acid, and thus, a composition for forming a photosensitive layer was obtained.

(Photosensitive Layer Formation Step)

A polyethylene terephthalate (PET) film having a thickness of 100 μm was subjected to a corona discharge treatment, and then, a gelatin layer having a thickness of 0.1 μm was disposed on both surfaces of the PET film described above as an undercoat layer, and an antihalation layer containing a dye which was decolored by an alkali of a developer having an optical concentration of approximately 1.0 was disposed on the undercoat layer. The composition for forming a photosensitive layer described above was applied onto the antihalation layer described above, and a gelatin layer having a thickness of 0.15 μm was further disposed, and thus, a PET film including the photosensitive layer on both surfaces thereof was obtained. The obtained film was set to a film A. In the formed photosensitive layer, the amount of silver was 6.0 g/m², and the amount of gelatin was 1.0 g/m².

(Exposure Development Step)

Exposure was performed with respect to both surfaces of the film A described above through a photomask in which a detection electrode (a first detection electrode and a second detection electrode) and lead-out wiring (first lead-out wiring and second lead-out wiring) were arranged as illustrated in FIG. 4 by parallel light using a high pressure mercury lamp as a light source. Development was performed by using a developer after the exposure, and a development treatment was performed by using a fixing liquid (Product Name: N3X-R for CN16X, manufactured by Fujifilm Corporation). Further, rinsing was performed by using pure water, and drying was performed, and thus, an electrostatic capacitance type touch panel sensor A comprising the detection electrode and the lead-out wiring which were formed of an Ag thin wire on the both surfaces was obtained.

Furthermore, in the obtained electrostatic capacitance type touch panel sensor A, the detection electrode was configured of metal thin wires which intersected with each other into the shape of a mesh, and the width of the metal thin wire/the width of the opening portion was 4.0 μm/296 μm. In addition, as described above, the first detection electrode is an electrode extending in an X direction, the second detection electrode is an electrode extending in a Y direction, and the first detection electrode and the second detection electrode are respectively arranged on the film at a pitch of 4.5 mm to 5 mm.

Next, a touch panel including a liquid crystal display device, a lower adhesive layer, an electrostatic capacitance type touch panel sensor, an upper adhesive layer, and a glass substrate in this order was manufactured by using each adhesive sheet prepared in each synthesis example. Furthermore, the electrostatic capacitance type touch panel sensor A described above was used as the electrostatic capacitance type touch panel sensor.

In a manufacturing method of the touch panel, one peeling sheet on the surface of the adhesive sheet described above was peeled off, the adhesive sheet described above was bonded onto the electrostatic capacitance type touch panel sensor by using a roller having a weight of 2 kg, and the upper adhesive layer was prepared, and the other peeling sheet was peeled off, and similarly, the glass substrate having the same size as that of the upper adhesive layer was bonded onto the upper adhesive layer by using a roller having a weight of 2 kg. After that, exposure was performed in a high pressure thermostatic tank in an environment of a temperature of 40° C. and a pressure of 5 atm for 20 minutes, and a defoaming treatment was performed.

Next, a lower adhesive layer was arranged between the electrostatic capacitance type touch panel sensor having a structure in which the glass substrate, the upper adhesive layer, and the electrostatic capacitance type touch panel sensor described above were bonded to each other in this order and a liquid crystal display device by using the adhesive sheet used for preparing the upper adhesive layer according to the same procedure as that of preparing the upper adhesive layer described above, and thus, the electrostatic capacitance type touch panel sensor and the liquid crystal display device were bonded to each other.

After that, the touch panel obtained as described above was exposed in a high pressure thermostatic tank in an environment of a temperature of 40° C. and a pressure of 5 atm for 20 minutes, and thus, a predetermined touch panel was manufactured.

Furthermore, the adhesive sheet in each of the examples is used as the lower adhesive layer and the upper adhesive layer in the touch panel described above (refer to Table 1).

Furthermore, in each of the examples, the length of a diagonal line of a touch unit (a sensing unit) in the electrostatic capacitance type touch panel sensor was 5 inches to be matched with the size of a display screen of the liquid crystal display device (the length of a diagonal line).

The temperature of the touch panel prepared as described above gradually rose from −40° C. to 80° C. by 20° C., and the incidence of malfunction at the time of being touched at each temperature was measured. That is, under an environment of −40° C., −20° C., 0° C., 20° C., 40° C., 60° C., and 80° C., an arbitrary portion was touched 100 times, and the incidence of malfunction (%) of the touch panel [(Number of Abnormal Reactions/100)×100] was measured from the number of abnormal reactions.

### Examples 21 and 22

A laminate for a touch panel and an electrostatic capacitance type touch panel sensor were prepared according to the same procedure as that in Example 1 except that a substrate described below was used instead of each of the polyethylene terephthalate (PET) used at the time of preparing the laminate for a touch panel and the electrostatic capacitance type touch panel sensor, and various evaluations (disconnection evaluation, temperature dependency evaluation, and malfunction evaluation) were performed.

Example 21: Cycloolefin Polymer (COP) ZEONOR (a thickness of 50 μm, manufactured by ZEON CORPORATION)

Example 22: Cycloolefin Copolymer (COC) ARTON (a thickness 50 μm, manufactured by Daicel Corporation)

Furthermore, “-” in Table 1 indicates that the evaluation is not performed.

TABLE 1

| | | | | | Evaluation | | |
|---|---|---|---|---|---|---|---|
| | | Thermal | | | | | Incidence of |
| | Type of | Expansion | Thermal | Peeling Strength | Disconnection | Temperature | Malfunction |
| | Adhesive Sheet | Factor (ppm/° C.) | Stress (pa) | (N/25 mm) | Evaluation | Dependency | (Maximum Value) |
| Example 1 | 1 | 150 | 500 | 0.70 | A | 4% | 0% |
| Example 2 | 2 | 150 | 550 | 0.96 | A | 4% | 0% |
| Example 3 | 3 | 150 | 480 | 0.94 | A | 4% | 0% |
| Example 4 | 4 | 150 | 300 | 0.60 | A | 3% | 0% |
| Example 5 | 5 | 150 | 380 | 0.84 | A | 3% | 0% |
| Example 6 | 6 | 150 | 350 | 0.79 | A | 3% | 0% |
| Example 7 | 7 | 150 | 390 | 0.60 | A | 3% | 0% |
| Example 8 | 8 | 150 | 550 | 0.55 | B | 4% | 0% |
| Example 9 | 9 | 150 | 560 | 0.40 | D | — | — |
| Example 10 | 10 | 150 | 1,300 | 1.04 | A | 4% | 0% |
| Example 11 | 11 | 150 | 1,200 | 1.16 | A | 4% | 0% |
| Example 12 | 12 | 150 | 400 | 0.50 | C | — | — |
| Example 13 | 13 | 150 | 450 | 0.45 | D | — | — |
| Example 14 | 14 | 150 | 1,690 | 0.53 | D | — | — |
| Example 15 | 15 | 150 | 390 | 0.45 | D | — | — |
| Example 16 | 16 | 150 | 1,580 | 0.51 | D | — | — |
| Example 17 | 17 | 150 | 490 | 0.48 | D | — | — |
| Example 18 | 18 | 150 | 1,080 | 0.51 | C | — | — |
| Example 19 | 19 | 150 | 1,270 | 0.46 | D | — | — |
| Example 20 | 20 | 150 | 1,750 | 0.52 | D | — | — |
| Example 21 | 1 | 70 | 500 | 0.70 | A | 4% | 0% |
| Example 22 | 1 | 75 | 500 | 0.70 | A | 4% | 0% |
| Comparative | 21 | 150 | 6,280 | 0.04 | E | — | — |
| Example 1 | | | | | | | |
| Comparative | 22 | 150 | 450 | 0.18 | E | — | — |
| Example 2 | | | | | | | |
| Comparative | 23 | 150 | 200 | 0.25 | E | — | — |
| Example 3 | | | | | | | |
| Comparative | 24 | 150 | 600 | 0.28 | E | — | — |
| Example 4 | | | | | | | |
| Comparative | 25 | 150 | 2,500 | 0.56 | E | — | — |
| Example 5 | | | | | | | |

As shown in Table 1, in the laminate for a touch panel of the present invention, the disconnection of the metal thin wire rarely occurred.

In particular, as it was known from the comparison between Example 1 and Example 8, it was confirmed that in a case where the amount of component (F) was greater than the amount of other components (in a case where the amount of component (F) was greater than or equal to 1.5 mass % with respect to the total amount of components (A) to (F)), a more excellent effect was able to be obtained.

In addition, as it was known from the comparison between Example 13 and Examples 1 to 8 and 10 to 12, it was confirmed that in a case where the component (F) was used, a more excellent effect was able to be obtained.

In addition, as it was known from the comparison between Examples 1 and 7 and Example 12, it was confirmed that in a case where an epoxy group and an oxetanyl group were used as a reactive group in the component (F), a more excellent effect was able to be obtained.

In addition, from the comparison between each of the examples, it was confirmed that in a case where peeling strength was greater than or equal to 0.50 N/25 mm, a more excellent effect was able to be obtained.

In addition, from the comparison between Examples 14, 16, and 20 and Example 12, it was confirmed that in a case where the degree of peeling was the same (greater than or equal to 0.50 and less than 0.55) or the value of thermal stress was less than or equal to 1,500 Pa, a more excellent effect was able to be obtained.

In contrast, in Comparative Examples 1 and 5 where the thermal stress was not in a predetermined range, and Comparative Examples 2 to 4 where the peeling strength was not in a predetermined range, a desired effect was not able to be obtained.

In the examples described above, the exposure was performed through the photomask in the shape of a square lattice providing the conductive pattern in which a plurality of square lattices having the width Wa of the metal thin wire/the width Wb of the opening portion of 4.0 μm/296 μm were arranged by the parallel light using a high pressure mercury lamp as a light source, but even in a case where the width Wa of the metal thin wire/the width Wb of the opening portion was changed to 10.0 μm/190 μm, the same effect was obtained. That is, even in a case where the arrangement pitch of the mesh in the mesh pattern was 200 μm, a desired effect was obtained.

### EXPLANATION OF REFERENCES

10: laminate for touch panel
12: resin substrate
14: metal thin wire
16: conductive portion
18: adhesive layer
20: protective substrate
22: resin substrate
24, 24a: first detection electrode
26, 26a: first lead-out wiring
28, 28a: second detection electrode
30: second lead-out wiring
32: flexible printed wiring board
34: metal thin wire
36: opening portion
38: first substrate
40: adhesive sheet
42: second substrate
50: display device
100: electrostatic capacitance type touch panel
200: aluminum electrode
180, 280, 380: electrostatic capacitance type touch panel sensor

What is claimed is:

1. A laminate for a touch panel, comprising:
a resin substrate which has a thermal expansion factor of 2 ppm/° C. to 200 ppm/° C.;
a conductive portion which is arranged on the resin substrate, and has a mesh pattern formed of a metal thin wire; and
an adhesive layer which is arranged to cover a surface of the resin substrate on the conductive portion side and the conductive portion,
wherein thermal stress obtained by Expression (1) described below is less than or equal to 1,800 Pa, and
peeling strength of the adhesive layer with respect to the resin substrate under an environment of a temperature of 85° C. and humidity of 85% is greater than or equal to 0.40 N/25 mm:
σ_{A}={|α_{B}−α_{A}|×ΔT×h_{B}×E_{A}×E_{B}}/(E_{A}×h_{A}+E_{B}×h_{B}) Expression (1)
in Expression (1), σ_{A} represents thermal stress, α_{A} represents a thermal expansion factor of the adhesive layer, α_{B} represents the thermal expansion factor of the resin substrate, ΔT represents 85° C.—room temperature, E_{A} represents a modulus of elasticity of the adhesive layer at 85° C., E_{B} represents a modulus of elasticity of the resin substrate at 85° C., h_{A} represents a thickness of the adhesive layer, h_{B} represents a thickness of the resin substrate, a unit of the thermal expansion factor of the adhesive layer and the thermal expansion factor of the resin substrate is ppm/° C., a unit of the modulus of elasticity of the adhesive layer at 85° C. and the modulus of elasticity of the resin substrate at 85° C. is Pa, and a unit of the thickness of the adhesive layer and the thickness of the resin substrate is mm.

2. The laminate for a touch panel according to claim 1,
wherein the adhesive layer is an adhesive layer obtained by photocuring a photocurable adhesive composition containing components (A) to (F) described below;
(A) a rubber,
(B) a crosslinking agent,
(C) a monofunctional (meth)acrylic monomer having at least one group selected from the group consisting of a straight chain or branch alkyl group having greater than or equal to 8 carbon atoms and an alicyclic hydrocarbon group,
(D) a photopolymerization initiator,
(E) an adhesiveness providing agent, and
(F) a compound which has at least one reactive group selected from the group consisting of an epoxy group, an oxetanyl group, an isocyanate group, a carbodiimide group, and an amino group, and at least one polymerizable group selected from the group consisting of a radically polymerizable group and an epoxy group, and is different from the components (A) to (E).

3. The laminate for a touch panel according to claim 2,
wherein a content of the component (C) in the photocurable adhesive composition is 10 mass % to 45 mass % with respect to the total mass of the components (A) to (F), and a content of the component (E) in the photocurable adhesive composition is 25 mass % to 50 mass % with respect to the total mass of the components (A) to (F).

4. The laminate for a touch panel according to claim 2,
wherein the component (B) contains one selected from the group consisting of polybutadiene, polyisoprene, hydrogenated polybutadiene, and hydrogenated polyisoprene, which have a (meth)acryloyl group.

5. The laminate for a touch panel according to claim 3,
wherein the component (B) contains one selected from the group consisting of polybutadiene, polyisoprene, hydrogenated polybutadiene, and hydrogenated polyisoprene, which have a (meth)acryloyl group.

6. The laminate for a touch panel according to claim 2,
wherein the component (F) is a compound denoted by General Formula (X), and 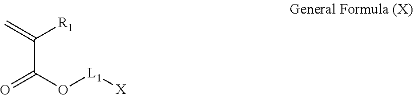
in General Formula (X), R₁ represents hydrogen, a methyl group, a trifluoromethyl group, or a hydroxy methyl group, L₁ represents alkylene or alkylene oxide, and X represents a group having at least one reactive group selected from an epoxy group, an oxetanyl group, an isocyanate group, a carbodiimide group, and an amino group.

10. The laminate for a touch panel according to claim 2,
wherein a content of the component (F) in the photocurable adhesive composition is 2 mass % to 20 mass % with respect to the total mass of the component (C).

11. The laminate for a touch panel according to claim 3,
wherein a content of the component (F) in the photocurable adhesive composition is 2 mass % to 20 mass % with respect to the total mass of the component (C).

12. The laminate for a touch panel according to claim 4,
wherein a content of the component (F) in the photocurable adhesive composition is 2 mass % to 20 mass % with respect to the total mass of the component (C).

13. The laminate for a touch panel according to claim 5,
wherein a content of the component (F) in the photocurable adhesive composition is 2 mass % to 20 mass % with respect to the total mass of the component (C).

14. The laminate for a touch panel according to claim 6,
wherein a content of the component (F) in the photocurable adhesive composition is 2 mass % to 20 mass % with respect to the total mass of the component (C).

15. The laminate for a touch panel according to claim 7,
wherein a content of the component (F) in the photocurable adhesive composition is 2 mass % to 20 mass % with respect to the total mass of the component (C).

16. An adhesive sheet obtained by photocuring a photocurable adhesive composition containing components (A) to (F) described below;
(A) a rubber,
(B) a crosslinking agent,
(C) a monofunctional (meth)acrylic monomer having at least one group selected from the group consisting of a straight chain or branch alkyl group having greater than or equal to 8 carbon atoms and an alicyclic hydrocarbon group,
(D) a photopolymerization initiator,
(E) an adhesiveness providing agent, and
(F) a compound which has at least one reactive group selected from the group consisting of an epoxy group, an oxetanyl group, an isocyanate group, a carbodiimide group, and an amino group, and at least one polymerizable group selected from the group consisting of a radically polymerizable group and an epoxy group, and is different from the components (A) to (E).

17. The adhesive sheet according to claim 16,
wherein a content of the component (C) in the photocurable adhesive composition is 10 mass % to 45 mass % with respect to the total mass of the components (A) to (F), and a content of the component (E) in the photocurable adhesive composition is 25 mass % to 50 mass % with respect to the total mass of the components (A) to (F).

18. The adhesive sheet according to claim 16,
wherein the component (B) contains one selected from the group consisting of polybutadiene, polyisoprene, hydrogenated polybutadiene, and hydrogenated polyisoprene, which have a (meth)acryloyl group.

19. The adhesive sheet according to claim 16,
wherein the component (F) is a compound denoted by General Formula (X), and 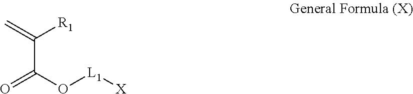
in General Formula (X), R₁ represents hydrogen, a methyl group, a trifluoromethyl group, or a hydroxy methyl group, L₁ represents alkylene or alkylene oxide, and X represents a group having at least one reactive group selected from an epoxy group, an oxetanyl group, an isocyanate group, a carbodiimide group, and an amino group.

20. The adhesive sheet according to claim 16,
wherein a content of the component (F) in the photocurable adhesive composition is 2 mass % to 20 mass % with respect to the total mass of the component (C).
